(19) United States
(12) Patent Application Publication
(10) Pub. No.: US 2026/0277243 A1
(43) Pub. Date: Sep. 17, 2026

(54) SYSTEM AND METHOD FOR AN AUTOMATED GUIDED VEHICLE WITH SCANNING COLLAR

(71) Applicant: Brian Marcuzzo, Mobile, AL (US)

(72) Inventor: Brian Marcuzzo, Mobile, AL (US)

(21) Appl. No.: 19/569,738

(22) Filed: Mar. 17, 2026

Related U.S. Application Data
(60) Provisional application No. 63/773,284, filed on Mar. 17, 2025.

(51) Int. Cl. G05D 1/667; G05D 105/28; G05D 105/80; G05D 107/70; G05D 109/18; G05D 111/10; G05D 111/30; G06Q 10/0832; H04W 4/40; H04W 4/80

(52) U.S. Cl. CPC G05D 1/667; G06Q 10/0832; H04W 4/40; H04W 4/80; G05D 2105/28; G05D 2105/89; G05D 2107/70; G05D 2109/18; G05D 2111/10; G05D 2111/30

(57) ABSTRACT

The present disclosure provides a system for scanning and transporting shipping containers. The system includes a rectangular bed for container transport, a sensor to detect container presence, Mecanum wheels for omnidirectional movement, engines with dual power options, and a scanning collar with multiple sensors for comprehensive container scanning. The system features a communications interface, alarm system, perimeter cameras, and a driving station with an enclosed cab. A computing entity may control various functions of the system, including, but not limited to, system operations, scanning processes, analyze scan data, transmit alerts, activate alarms, and direct the system to predetermined locations based on risk assessment. The disclosure also includes a method for scanning and sorting containers using the described system.

### CROSS REFERENCE TO RELATED APPLICATIONS

This application claims the benefit of U.S. Provisional Application 63/773,284, filed on Mar. 17, 2025, which is herein incorporated entirely by reference.

### FIELD OF INVENTION

The present disclosure relates to port security vehicles, and more particularly to self-driving vehicles used to sort and transport shipping containers.

### BACKGROUND

The shipping industry plays a pivotal role in global trade, serving as the backbone for the movement of goods across international borders. This industry relies heavily on efficient and secure container handling processes to ensure the smooth flow of commerce. However, the traditional methods currently employed for scanning and sorting shipping containers are riddled with inefficiencies that can significantly hinder port operations. Typically, these methods involve the use of stationary inspection facilities, where containers must be transported for scanning and security checks. This multi-step process often includes the deployment of X-ray scanners, radiation detectors, and manual inspections, all of which require that shipping containers be moved to specific, dedicated inspection areas. Consequently, this approach leads to increased handling times and a marked reduction in overall port efficiency.

The reliance on stationary facilities creates a bottleneck effect, as containers must be queued and processed in a sequential manner, which can delay the entire supply chain. The segmented nature of this approach not only extends the processing time required for each container but also introduces additional logistical challenges. Managing the flow of containers through various inspection stages becomes a complex task, requiring careful coordination and allocation of resources. This can lead to congestion within the port, as well as increased labor costs and resource allocation to manage these processes. Furthermore, the need to transport containers to and from inspection facilities adds an extra layer of complexity and cost, as it requires additional equipment and personnel to move the containers. These inefficiencies underscore the need for a more integrated and streamlined approach to container handling and inspection. By addressing these challenges, the shipping industry can enhance its operational efficiency, reduce costs, and improve the security of goods in transit. This is particularly important in an era where global trade is increasingly reliant on just-in-time delivery and the rapid movement of goods across borders. As such, there is a pressing need for innovative solutions that can overcome the limitations of traditional methods and support the continued growth and security of global trade.

The current protocols are further suboptimal because they fail to provide continuous monitoring of containers throughout their journey within the port environment. The lack of integration between transportation and inspection systems results in redundant handling steps and inefficient use of port space and resources. Moreover, failure to monitor all packages shipping containers entering the United States does not fully align with the objectives of US Code Title 6, chapter 3, subsection 982, enacted as part of the Department of Homeland Security Appropriations Act, 2007, which emphasizes the importance of securing the nation's ports and transportation systems, highlighting the need for improved security measures that can detect and mitigate potential threats in real-time. By enabling continuous monitoring and integrating scanning technologies with transportation systems, the shipping industry could achieve significant reductions in processing times, minimize the need for dedicated inspection facilities, and enhance overall port security. As such, improvements in processing and scanning are needed for maintaining the integrity and efficiency of global trade, ensuring that ports can operate smoothly while safeguarding against potential security threats.

Accordingly, there is a need in the art for a system and method for a self-driving vehicle that automatically transports and scans shipping containers for dangerous or restricted materials.

### SUMMARY

A system and method for automatically scanning and transporting shipping containers is provided. In one aspect, the present invention is a vehicle for facilitating the safe transport of shipping containers within a port setting. In another aspect, the present invention is a mobile scanning device enabling the collection of various safety data from goods in transit. In yet another aspect, the present invention is a means for reducing the number of safety personnel and locations in port locations where space is competitive and limited. In still another aspect, the present invention is a method for scanning, sorting, and transporting shipping containers using a vehicle of the system. Generally, the present invention is aimed towards streamlining and safeguarding the process of transporting shipping containers about a port.

The system preferably comprises a rectangular bed suitable for transporting shipping containers, wherein said shipping container is positioned on said rectangular bed. A sensor integrated about said rectangular bed may be configured to detect the presence of shipping containers, wherein said sensor preferably comprises at least one of a pressure sensor or a camera. For omnidirectional movement, the system may incorporate a plurality of wheels, preferably Mecanum wheels, with engines powered by direct current or diesel. A communications interface comprising a transmitter and receiver enables the control of the system by a user and/or a processor of the system. A driving station may also be operably connected to the rectangular bed, comprising a control panel and optionally an enclosed cab.

The system preferably includes a scanning collar configured to gather data from a shipping container on the rectangular bed. These sensors may comprise an X-ray scanner, a gamma ray scanner, a thermal camera, a radiation detector, a volatile organic compound detector, and a spectroscopic analyzer. The scanning collar gathers data from the shipping container by traversing the length of the rectangular bed with one or more sensors active. The system may further comprise an alarm to audibly alert nearby personnel to the presence of a hazard. One or more cameras configured to gather visual data of the surroundings of said system, preferably mounted about the perimeter of the bed of the system, allow the system to navigate the port setting automatically. These functions are coordinated by a computing entity comprising a processor and a non-transitory computer-readable medium coupled to said processor operably connected to the container sensor, alarm, control panel in the driving station, communication interface, engines, and scanning collar.

A method for scanning and sorting containers is also provided. The method utilizes the system and includes interpreting signals from a local handset via Bluetooth to generate a set of directives for the operation of a system comprising a rectangular bed to control the direction, rotation, and speed of the motion of said system based on said signals. Safety operations are conducted by detecting the presence of a shipping container on said rectangular bed, initiating a scan of said shipping container, and collecting data from said scan of said shipping container. The data from the scan is then interpreted to determine a risk level of the container and reacting with distinct protocols based on the risk level. Risky containers prompt the transmission of an alert pertaining to said risk level to the appropriate personnel or authorities, the activation of alarms, and the direction of said system to travel to a predetermined safe location for follow up inspection, if necessary.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure. Further, it should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

These and other features, aspects, and advantages of the present invention will become better understood with regard to the following description, appended claims, and accompanying drawings where:

FIG. 1 illustrates a side view of the invention comprising a cab consistent with the principles of the present disclosure.

FIG. 2 illustrates a side view of the invention comprising a cab in use scanning a shipping container consistent with the principles of the present disclosure.

FIG. 3 illustrates a side view of the invention lacking a cab consistent with the principles of the present disclosure.

FIG. 4 illustrates a front orthogonal view of the scanning collar of the scanning collar of the invention with integrated sensors consistent with the principles of the present disclosure.

FIG. 5 illustrates a top view of the bed of the invention consistent with the principles of the present disclosure.

FIG. 6 illustrates a bottom view of the bed of the invention with wheels, engines, and fueling system consistent with the principles of the present disclosure.

FIG. 7 illustrates a configuration of a system suitable for operating the system consistent with the principles of the present disclosure.

FIG. 8 illustrates the method by which the system with integrated scanners may scan and sort shipping containers.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components. As defined herein, the word substantial means more than half of the length.

The present disclosure relates to systems and methods for automated guided vehicles configured to scan and transport shipping containers within port environments. In a preferred embodiment, the system comprises a mobile platform capable of carrying shipping containers while simultaneously performing security scans using an integrated scanning collar. The system may be configured to operate autonomously, semi-autonomously, or under manual control depending on operational conditions and user preferences. In some instances, the system can navigate complex port layouts using onboard sensors and cameras that gather environmental data for path planning and obstacle avoidance. The integration of transportation and scanning functions into a single vehicle platform may reduce the need for separate inspection facilities and minimize container handling steps. This approach can streamline port operations by enabling continuous monitoring of containers throughout their journey within the port.

In another preferred embodiment, the system incorporates a computing entity that coordinates the various subsystems including propulsion, navigation, scanning, and communications. The computing entity may process data from multiple sensor types to assess potential risks associated with container contents. In some preferred embodiments, the system can communicate with external devices and port management systems through wireless interfaces such as Bluetooth or cellular networks. Alternatively, the system may receive commands from an operator using a local handset or from a centralized control station. The modular design of the system allows for customization based on specific port requirements and security protocols. For example, a port handling primarily refrigerated goods may prioritize thermal scanning capabilities, while a port with heightened security concerns may emphasize radiation detection.

The scanning collar of the present disclosure may house various sensor types that can be activated individually or in combination during a scanning operation. In a preferred embodiment, the scanning collar traverses the length of a shipping container positioned on the vehicle bed, collecting data as it moves. The collected data may include X-ray imagery, thermal signatures, radiation measurements, volatile organic compound concentrations, and spectroscopic information. In some instances, the system can compare detected signatures against databases of known materials to identify potential threats or contraband. Optionally, the system may flag containers for further inspection by human operators when scan results indicate elevated risk levels. The ability to perform comprehensive scans during transport can reduce processing times and improve throughput at busy port facilities.

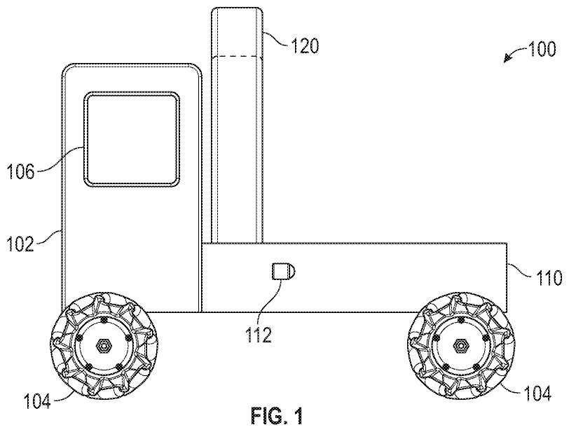

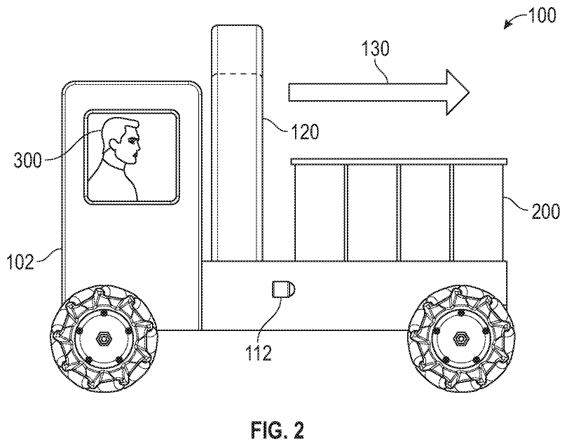

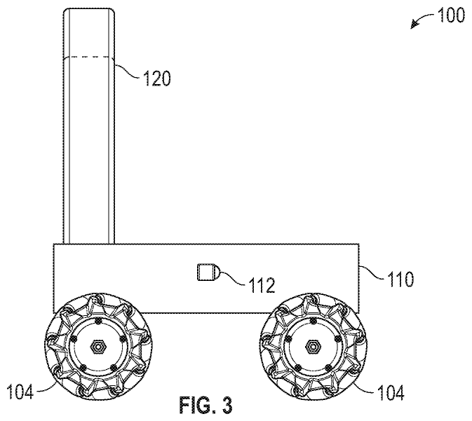

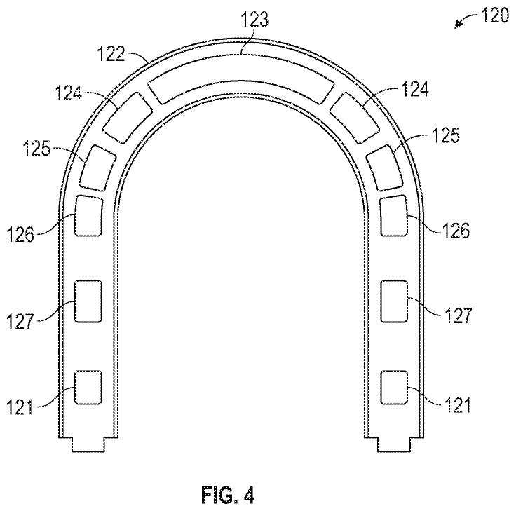

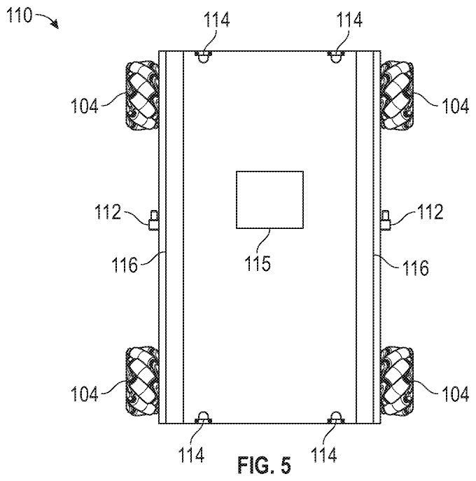

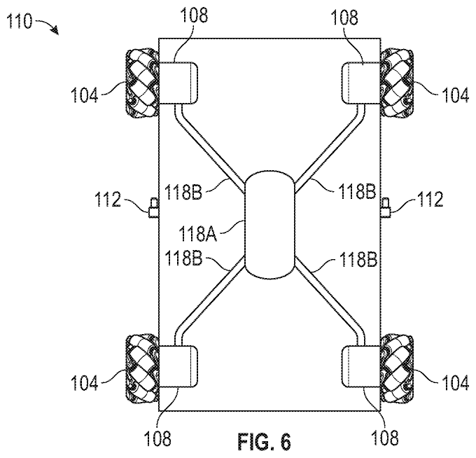

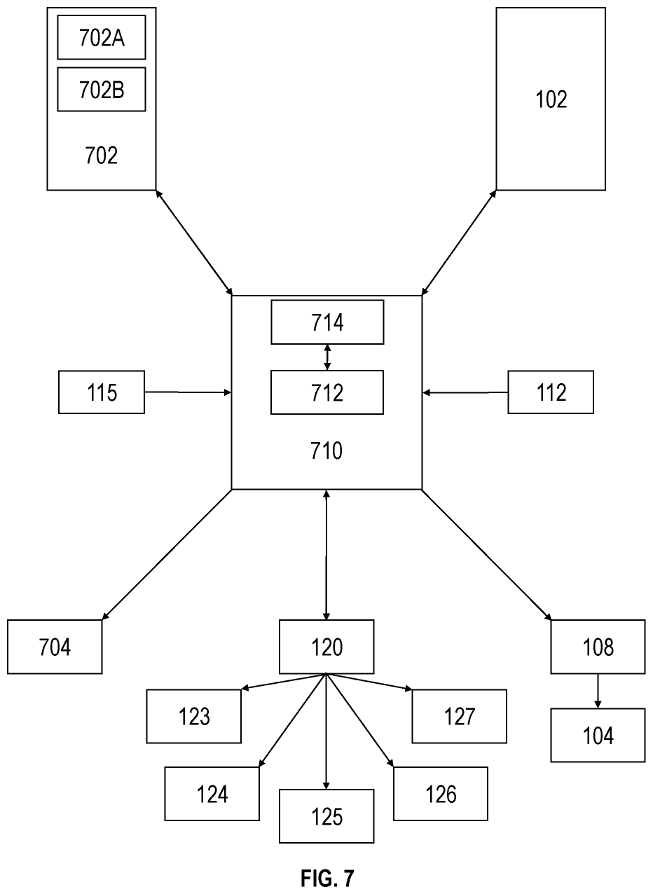

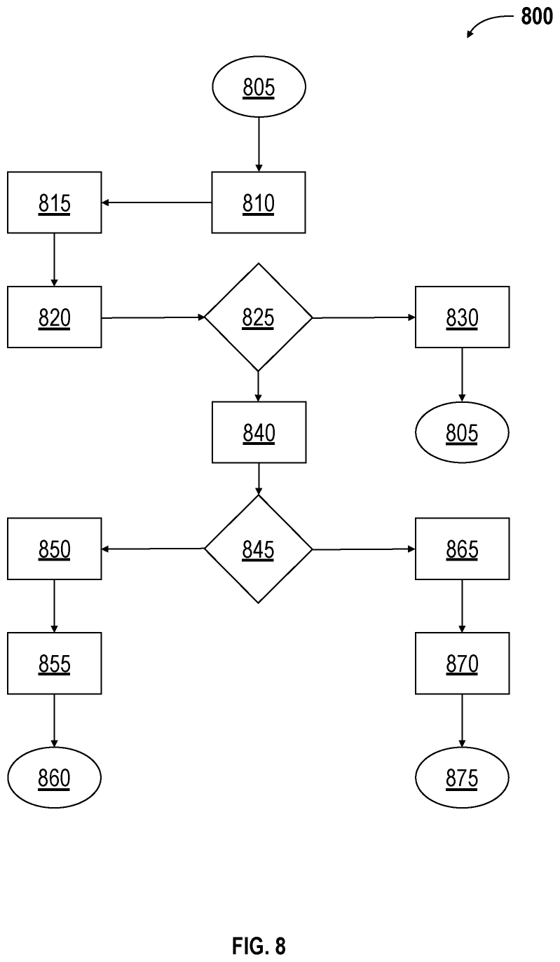

FIGS. 1-8 illustrate embodiments of a system and method for an automated guided vehicle with scanning collar. FIG. 1 illustrates a side view of the system 100 comprising a cab 102, Mecanum wheels 104, a cab window 106, a bed 110, a navigation camera 112, and a scanning collar 120 configured to enable scanning and transporting of shipping containers. FIG. 2 illustrates a side view of the system 100 in use scanning a shipping container 200, showing the cab 102, navigation camera 112, scanning collar 120, scan 130, and operator 300. FIG. 3 illustrates a side view of the system 100 lacking a cab, showing the Mecanum wheels 104, bed 110, navigation camera 112, and scanning collar 120. FIG. 4 illustrates a front orthogonal view of the scanning collar 120 comprising attachment ports 121, a collar frame 122, an X-ray scanner 123, a VOC detector 124, a thermal camera 125, a spectroscopic analyzer 126, and a radiation detector 127 for comprehensive container inspection. FIG. 5 illustrates a top view of the bed 110 showing Mecanum wheels 104, navigation camera 112, anchor loops 114, container sensor 115, and collar grooves 116. FIG. 6 illustrates a bottom view of the bed 110 showing Mecanum wheels 104, navigation camera 112, engine 108, fuel tank 118A, and fuel line 118B. FIG. 7 illustrates a configuration of a system suitable for operating the system, showing the cab 102, Mecanum wheels 104, navigation camera 112, scanning collar 120 with integrated sensors, container sensor 115, engine 108, communications interface 702 comprising transmitter 702A and receiver 702B, alarm 704, and computing entity 710 comprising processor 712 and non-transitory computer-readable medium 714. FIG. 8 illustrates a flowchart for a method 800 showing steps for scanning, sorting, and transporting shipping containers based on risk level determination. It is understood that the methods disclosed herein may be carried out by the system illustrated in FIGS. 1-6.

As illustrated in FIG. 1, the present disclosure describes a system 100 for scanning and transporting shipping containers within port environments. In a preferred embodiment, the system 100 includes a cab 102 positioned at one end of the vehicle platform, which may provide an enclosed space for an operator 300 to control and monitor operations. The cab 102 can serve as a protected workstation where the operator 300 may access controls, displays, and communication equipment while remaining shielded from external environmental conditions. Alternatively, the cab 102 may comprise an open seat configuration without a full enclosure, which can be suitable for temperate climates or operations where rapid ingress and egress are desirable. In another preferred embodiment, the cab 102 comprises a control panel operable by the operator 300 to control the system 100, including steering inputs, speed adjustments, and scanning initiation commands. The cab 102 may feature a cab window 106 that can allow for visibility and observation of the surrounding environment, enabling the operator 300 to maintain situational awareness during transport and scanning operations.

In some preferred embodiments, the cab 102 may be constructed using a combination of materials selected for durability, safety, and functionality in port environments. The frame of the cab 102 can be fabricated from high-strength steel or aluminum alloys, providing structural integrity while minimizing overall weight to improve fuel efficiency and maneuverability. The cab's exterior panels may be composed of impact-resistant composite materials or reinforced plastics, offering protection against potential collisions with port infrastructure or falling debris from overhead cranes. In some instances, the cab window 106 may be made of shatter-resistant polycarbonate or laminated safety glass, enhancing operator protection while maintaining clear visibility of the operational area. The interior of the cab 102 can feature flame-retardant materials for added safety in environments where flammable cargo may be present, and sound-dampening materials may be incorporated to reduce noise levels from port operations such as crane movements and vehicle traffic. Optionally, the cab's floor may be constructed with non-slip, corrosion-resistant materials to withstand exposure to various environmental conditions encountered in port settings, including saltwater spray, hydraulic fluid spills, and accumulated moisture.

In a preferred embodiment, the system 100 is supported by Mecanum wheels 104, which may be positioned at the corners of the system's undercarriage to provide stable and versatile mobility. As illustrated in FIG. 1, these Mecanum wheels 104 can be configured to operate both in tandem and independently, allowing for a wide range of movement patterns. The Mecanum wheels 104 enable omnidirectional movement, allowing the system 100 to maneuver in tight spaces and navigate complex port environments with precision, such as moving laterally between stacked container rows or rotating in place within confined loading areas. In another preferred embodiment, extending horizontally from the cab 102 is a bed 110, which may serve as the primary platform for container transport during scanning and relocation operations. The bed 110 can be designed with dimensions appropriate to accommodate standard shipping containers, such as twenty-foot equivalent units (TEUs) or forty-foot equivalent units (FEUs), and provide a stable surface during transportation and scanning operations. For instance, the bed 110 may be sized so that a standard shipping container fits upon the bed without extending off the rear edge, ensuring balanced weight distribution and safe transport.

The present disclosure describes a system 100 that may be configured to operate in four distinct modes, each offering unique advantages to accommodate various operational needs and scenarios within a port environment. The first mode is fully automated, utilizing a sophisticated array of navigation sensors, including, but not limited to, GPS sensors, LIDAR sensors, cameras, and prewritten computer algorithms stored on the computing entity 710. This mode allows the vehicle to navigate autonomously, making real-time decisions based on its surroundings and pre-programmed instructions without direct human intervention. The integration of these technologies enables the vehicle to efficiently maneuver through complex port environments, avoiding obstacles such as other vehicles, pedestrians, and temporary obstructions while optimizing its path for time and energy efficiency. In some instances, this mode can be particularly beneficial in high-traffic areas where precision and efficiency are paramount, such as during peak unloading periods when multiple vessels are being serviced simultaneously. The autonomous navigation capabilities may reduce operator fatigue and allow human personnel to focus on supervisory and exception-handling tasks rather than routine transport operations.

In a preferred embodiment, navigation cameras 112 may be mounted on the sides of the bed 110 and/or atop the cab 102 to provide comprehensive visual coverage of the system's surroundings. As illustrated in FIG. 1, the navigation cameras 112 can capture real-time video data that assists with system positioning and navigation during various operational modes. In another preferred embodiment, the navigation camera or cameras may be mounted on the scanning collar 120, providing additional viewing angles that can be particularly useful when the collar is traversing a container during scanning operations. When an operator 300 is personally driving the system 100, these cameras may assist with system positioning and navigation by displaying video feeds on monitors within the cab 102 or on a local handset used by the operator 300. In some preferred embodiments, the video data recorded by the navigation cameras 112 can be sent to the computing entity 710, which uses it when self-driving features of the system are engaged to navigate a space and avoid collisions. The navigation cameras 112 may optionally include night vision or low-light capabilities to support operations during evening shifts or in poorly illuminated areas of the port.

The second mode of navigation involves a manual operator who is physically present on or within the automated guided vehicle (AGV), providing a hands-on approach to vehicle control that leverages human judgment and adaptability. This mode can be particularly advantageous in scenarios where human intuition is valuable, allowing the operator 300 to directly influence the vehicle's movements with precision and responsiveness to changing conditions. By being on board, the operator 300 may respond immediately to dynamic and unpredictable conditions that can arise within the port environment, such as sudden obstacles, changes in traffic patterns, or unexpected instructions from port authorities regarding container priorities. In a preferred embodiment, this direct control is facilitated through a user-friendly interface, typically located within the cab 102 or control station on the vehicle, which provides the operator 300 with comprehensive access to the vehicle's navigation and operational systems. The presence of a manual operator can be beneficial in environments where automated systems might encounter challenges due to complex or nuanced variables that benefit from human oversight, such as areas with high pedestrian traffic or where delicate cargo handling is involved. Additionally, having an operator 300 on board allows for immediate troubleshooting and intervention in case of technical issues, potentially reducing downtime and maintaining the flow of operations.

In some preferred embodiments, this mode may enhance the vehicle's flexibility, as the operator 300 can seamlessly transition between automated and manual control as needed, providing a hybrid approach that leverages the strengths of both human and machine capabilities. The operator's ability to directly observe and interact with the environment from the vehicle's vantage point can help maintain a high level of situational awareness, which may be valuable for safety and operational effectiveness in busy port settings. For instance, an operator 300 may take manual control when approaching a congested intersection within the port and then re-engage automated navigation once the area is cleared. In another preferred embodiment, the control panel within the cab 102 may include tactile feedback mechanisms that allow the operator 300 to sense vehicle responses without looking away from the operational environment. The manual operation mode can also serve as a training platform for new operators who are learning the port layout and operational procedures before transitioning to supervisory roles over automated systems. Overall, the second mode of navigation offers a solution for scenarios where human expertise and decision-making complement the vehicle's automated capabilities.

The third mode of operation may introduce a remote-control capability, allowing a manual operator to manage the vehicle's movements from a distance using a remote communication interface such as a Bluetooth-enabled handset. This mode can offer significant flexibility and safety advantages, particularly in environments that are hazardous or restricted, where direct human presence on the vehicle is either impractical or poses safety concerns. In a preferred embodiment, by utilizing a wireless connection, this mode may provide secure and reliable communication between the operator's handset and the vehicle, facilitating the execution of commands with minimal latency for responsive control. This connectivity can be valuable for maintaining precise control over the vehicle's operations, even when the operator 300 is not physically present on board the system 100. In some instances, the operator 300 may effectively navigate the vehicle through complex port environments while responding to real-time conditions and making adjustments to the vehicle's path from a safe observation point. The ability to control the vehicle remotely can be particularly beneficial in situations where the terrain or operational conditions pose risks to human safety, such as areas where hazardous materials have been detected, extreme weather conditions are present, or high-risk security zones have been established.

In another preferred embodiment, this mode may enhance operational efficiency by allowing operators to manage multiple vehicles from a single location, potentially optimizing resource allocation and reducing the need for on-site personnel at each vehicle. The remote-control interface can be designed to be intuitive and user-friendly, providing operators with comprehensive access to the vehicle's navigation and operational systems through graphical displays and responsive controls. For instance, an operator 300 stationed at a covered observation platform may control a system 100 operating in an open area during inclement weather while remaining protected from the elements. In some preferred embodiments, the handset may display real-time video feeds from the navigation cameras 112, allowing the operator 300 to maintain visual awareness of the vehicle's surroundings despite the physical separation. The Bluetooth communication protocol may be configured to operate within a defined range appropriate for port operations, with automatic safety protocols engaging if the connection is interrupted or signal strength falls below acceptable thresholds. Overall, the third mode of navigation offers a versatile and adaptable solution for modern port operations, combining the benefits of remote control with the reliability of secure communication technology.

The fourth mode of navigation involves manual operation of the vehicle by an operator positioned at a remote operator's station, which may be located in a centralized control facility within the port. This configuration can allow the operator to manage the vehicle from a centralized location, offering the capability to oversee multiple vehicles simultaneously through integrated display systems and control interfaces. In a preferred embodiment, this mode may be particularly advantageous for large-scale operations where centralized control and coordination are valuable for maintaining efficiency and effectiveness across a fleet of vehicles. By centralizing the control operations, this mode can facilitate streamlined management of resources and personnel, potentially reducing the need for operators to be physically present at each vehicle during routine operations. The remote operator's station may be equipped with advanced interfaces that provide real-time data and visual feedback from the vehicle's array of sensors, including the navigation cameras 112 and scanning collar 120 sensors. This comprehensive data stream can allow the operator to maintain situational awareness, making informed decisions and adjustments to the vehicle's operations as conditions change within the port environment.

In some preferred embodiments, this mode may significantly enhance operational efficiency by enabling a single operator to manage multiple vehicles, thereby potentially optimizing resource allocation across the port's container handling operations. The centralized control system can allow for coordinated movements and operations across the fleet of vehicles, helping to ensure that tasks are completed in a timely and efficient manner with reduced risk of vehicle conflicts or scheduling delays. For instance, a single operator at a control station may coordinate the movements of several systems 100 to efficiently clear containers from a newly arrived vessel while avoiding congestion at sorting zones. Additionally, this setup may reduce the need for on-site personnel at each vehicle, which can lead to cost efficiencies and improved safety, as operators are not exposed to potentially hazardous conditions in the field during routine operations. In another preferred embodiment, the remote operator's station may include ergonomic workstation designs that support extended operational periods without operator fatigue, including adjustable seating, multiple monitor configurations, and climate-controlled environments. Overall, the fourth mode of navigation offers a scalable solution for managing complex port operations by leveraging centralized control and real-time data feedback from the system 100.

As illustrated in FIG. 1, the scanning collar 120 represents a notable feature of the system 100 that may be configured to perform comprehensive inspections of shipping containers during transport. In a preferred embodiment, the scanning collar 120 extends vertically from the bed 110 in a semicircular or horseshoe shape, with an internal diameter of sufficient dimensions to fit about a standard shipping container such as a twenty-foot or forty-foot intermodal container. The scanning collar 120 can be configured to perform various scanning operations on containers 200 positioned on the bed 110, utilizing one or more integrated sensors to collect data about the container's contents. In another preferred embodiment, the collar's design allows it to encompass or traverse the length of a shipping container, collecting risk data from one or more sensors as it travels in a single scan 130 along collar grooves 116 on the bed 110. The scanning collar 120 may house multiple types of sensors for comprehensive container inspection, including X-ray scanners 123, VOC detectors 124, thermal cameras 125, spectroscopic analyzers 126, and radiation detectors 127 as illustrated in FIG. 4. In some instances, the sensors may be utilized in a scan 130 individually, in combination, or in subsets of the whole depending on the specific inspection protocol or the type of cargo being examined.

As illustrated in FIG. 2, the present disclosure describes a side orthogonal view of the system 100 actively engaged in scanning a shipping container 200. In a preferred embodiment, the scanning collar 120 may be positioned adjacent to the shipping container 200 such that the shipping container 200 fits between the scanning collar 120 and the bed 110, thereby enabling the performance of a scan 130. The term “scan” as used herein refers to a process of collecting data from a container using one or more sensors, which can involve various methodologies depending on operational requirements and container characteristics. In some instances, the scan may involve moving sensors along the length, width, or height of the container, while alternatively, the sensors may be maintained in a fixed position while the container moves relative to the sensors. During a scan, various types of data may be collected, including, but not limited to, X-ray images, radiation measurements, thermal readings, audio/radio data, or chemical composition information that can assist in determining the safety profile of the container contents. The scan 130 may be performed in a single pass or multiple passes and can utilize one or more types of sensors simultaneously or sequentially depending on the scanning protocol selected by the operator 300 or the computing entity 710.

In another preferred embodiment, the scan 130 is represented by an arrow indicating the direction of the scanning operation along the length of the shipping container 200, which can provide visual feedback to operators monitoring the scanning process. The scanning collar 120 may be configured to traverse the shipping container 200 at varying speeds depending on the type of data being collected and the sensitivity of the sensors being employed. For instance, a slower traversal speed may be selected when performing detailed X-ray imaging to capture higher resolution images, while a faster speed may be appropriate for initial radiation screening passes. In some preferred embodiments, the system 100 can automatically adjust the scanning speed based on preliminary readings that indicate areas of interest within the container. The computing entity 710 may process real-time feedback from the sensors to optimize the scanning parameters during the operation. Optionally, the system 100 can perform multiple scanning passes with different sensor configurations to build a comprehensive data profile of the container contents.

As illustrated in FIG. 2, the presence of an operator 300 inside the cab 102 indicates human oversight of the scanning and transportation operations. The term “operator” as used herein refers to a human who through one or more means controls the activity of the system 100, whether through direct manual input or supervisory oversight of automated processes. In a preferred embodiment, the operator 300 may control the system 100 from inside the cab 102, utilizing the control panel and displays to monitor scanning progress and navigate the port environment. In another preferred embodiment, the operator 300 can control the system 100 from the exterior of the cab 102 in order to monitor its progress from an external vantage point that may provide better visibility of surrounding conditions. In some instances, the operator 300 may instruct the system 100 to execute its scanning and transportation algorithm while positioned out of the line of sight, such as from a covered observation area during inclement weather conditions. The operator 300 may be positioned to monitor and control the scanning process, either through direct manual operation through a control interface or by overseeing the automated scanning procedure from a remote location.

In a preferred embodiment, the operator 300 may operate the system 100 using a local handset that provides a convenient and flexible means of controlling the system 100 remotely. The local handset can allow the operator 300 to navigate and operate the AGV from a safe distance, which may be particularly advantageous when scanning containers that have triggered preliminary alerts or when operating in congested areas of the port. This handheld device may feature an operator-friendly interface with controls for steering, speed adjustment, and activation of various system functions such as initiating scans or adjusting the scanning collar 120 position. In another preferred embodiment, the handset used to operate the system 100 can be an application installed on a mobile phone, which may provide additional convenience by utilizing a device the operator 300 already carries. In some preferred embodiments, the handset may be configured to connect to the system 100 via Bluetooth, which offers several advantages over wired connections or other wireless technologies for short-range communication. For instance, Bluetooth connectivity can allow for secure communication between the handset and the system 100, reducing the risk of interference or unauthorized access while providing low power consumption that benefits both the handset and the system's power management.

The present disclosure describes a pairing process between the handset and the system 100 that may be configured to ensure that authorized operators 300 can control the AGV, thereby enhancing security in the port environment. In some instances, the Bluetooth-enabled handset can display real-time data from the system's sensors, allowing the operators 300 to monitor the scanning process and receive immediate alerts about potential threats detected during container inspections. For instance, an operator 300 monitoring a scan from across a loading area may receive a notification on the handset indicating elevated radiation levels before the scanning collar 120 has completed its traversal. Alternatively, the handset may display thermal imaging data that reveals temperature anomalies within the container that warrant further investigation. In a preferred embodiment, the handset interface can provide graphical representations of scan progress, including percentage completion indicators and preliminary risk assessments as data is collected. The operator 300 may optionally configure the handset to provide audible alerts for specific threat categories, allowing for hands-free monitoring while attending to other supervisory duties in the port environment.

In a preferred embodiment, the shipping container 200 may be a standardized intermodal container used for transporting goods in global trade, which can facilitate seamless transfer between different transportation modes. These containers are typically made of corrugated steel and may be configured to be transferred between different modes of transportation such as ships, trains, and trucks without requiring the contents to be unloaded and reloaded. In another preferred embodiment, the shipping container 200 can be a smaller intermodal container capable of fitting between the scanning collar 120 and the bed 110, which may be suitable for specialized cargo or partial shipments. These smaller containers may be secured in place via straps attached to the anchor loops 114 to hold them in place during scanning and transportation operations. For instance, a half-height container used for heavy machinery components may be positioned on the bed 110 and secured with multiple straps to prevent shifting during transit across uneven port surfaces. In some preferred embodiments, containers of various sizes may be composed of materials that permit gamma or X-ray imaging to penetrate and capture internal contents, though the imaging quality may vary based on container wall thickness and composition.

The present disclosure describes various container configurations that may be accommodated by the system 100 during scanning and transportation operations. In some instances, refrigerated containers with integrated cooling units may be scanned while maintaining their temperature control systems in operation, which can be advantageous for time-sensitive perishable goods. Alternatively, open-top containers used for oversized cargo may be scanned using modified protocols that account for the exposed upper surface of the container contents. In a preferred embodiment, the system 100 can accommodate tank containers used for liquid cargo, with the scanning collar 120 sensors adjusted to detect chemical signatures and density variations within the liquid contents. The computing entity 710 may store configuration profiles for different container types, allowing the operator 300 to select the appropriate scanning protocol based on the container being processed. In some preferred embodiments, the system 100 may automatically identify the container type using visual recognition through the navigation cameras 112 and suggest the corresponding scanning configuration to the operator 300 for approval before initiating the scan 130.

As illustrated in FIG. 3, the present disclosure describes a side orthogonal view of the system 100, showcasing an embodiment that may differ from FIG. 1 in several aspects relating to structural configuration and operational characteristics. In a preferred embodiment, the system 100 depicted in FIG. 3 can be configured without the cab 102 that was present in FIG. 1, resulting in a more streamlined profile that may allow for greater maneuverability in tight spaces within port environments. The absence of the cab 102 can reduce the overall mass that the system 100 transports, which may contribute to greater fuel efficiency and extended operational longevity before maintenance or repairs become advisable. In some instances, this cabless design may offer advantages in terms of a lower center of gravity, potentially enhancing stability when transporting heavy shipping containers across uneven port surfaces. The reduced vertical profile can also provide greater flexibility in cargo capacity or scanning capabilities, as the system 100 may be configured to accommodate taller containers or operate in areas with height restrictions such as covered loading docks or multi-level storage facilities. Alternatively, the weight savings from eliminating the cab 102 may allow for the integration of additional scanning equipment or larger battery systems for extended autonomous operation.

In another preferred embodiment, the cabless configuration of the system 100 may be particularly suited for port facilities that prioritize automated operations over manual control scenarios. The present disclosure contemplates that this design can facilitate integration with centralized fleet management systems that coordinate multiple vehicles simultaneously without requiring individual operators aboard each unit. In some preferred embodiments, the system 100 without a cab 102 may be configured to receive instructions exclusively through the communications interface 702, enabling seamless coordination with port logistics software that optimizes container routing and scheduling. For example, a high-volume container terminal in Rotterdam might deploy a fleet of cabless systems 100 that operate continuously in shifts without the constraints of operator fatigue or shift changes. The reduced complexity of the cabless design can also simplify manufacturing and assembly processes, potentially lowering production costs and accelerating deployment timelines for port facilities seeking to expand their automated handling capabilities. Optionally, the cabless embodiment may include enhanced sensor arrays positioned at locations that would otherwise be obstructed by cab structures, thereby improving the system's environmental awareness during autonomous navigation.

In a preferred embodiment, the navigation camera 112 in FIG. 3 may be repositioned compared to FIG. 1 to accommodate the structural differences of the cabless configuration. As there is no cab 102 upon which a navigation camera 112 may be mounted, the navigation cameras 112 can be mounted instead directly on the bed 110 or integrated into the scanning collar 120 to maintain the system's ability to gather visual data for navigation and positioning purposes. In some preferred embodiments, the navigation cameras 112 may be configured to provide panoramic coverage through strategic placement at multiple points along the bed 110 perimeter, compensating for the elevated vantage point that would otherwise be provided by cab-mounted cameras. The present disclosure contemplates that mounting navigation cameras 112 at bed level can offer certain advantages, such as improved detection of ground-level obstacles including debris, curbs, or uneven pavement that might affect vehicle stability during transport operations. Alternatively, retractable camera masts may be incorporated into the bed 110 design, allowing the navigation cameras 112 to be elevated during navigation sequences and lowered during scanning operations to avoid interference with the scanning collar 120 movement. In some instances, the navigation cameras 112 positioned on the scanning collar 120 may provide dual functionality by capturing both navigation data and visual documentation of container exteriors during scanning procedures.

In another preferred embodiment, the absence of the cab 102 can facilitate fully autonomous operation or remote control configurations, which may eliminate the need and capacity for an on-board operator during routine transport and scanning operations. The present disclosure describes how this embodiment may be particularly advantageous for ports implementing around-the-clock operations where continuous vehicle availability is desirable without the logistical challenges of staffing multiple operator shifts. In some instances, this embodiment may be implemented in climates where extreme weather conditions are not prevalent and therefore operators do not frequently need shelter from environmental elements. For example, a port facility in San Diego, which typically experiences mild temperatures and minimal precipitation throughout the year, might select a cabless design to maximize operational efficiency, while a facility in Seattle, where frequent rain and variable conditions are common, may prefer an embodiment with a cab 102 to protect operators during manual operation periods. The cabless system 100 can optionally be equipped with weather-resistant housings for electronic components and sensors, enabling reliable operation even in occasional adverse conditions without the structural overhead of a full cab enclosure. In some preferred embodiments, port facilities may deploy a mixed fleet comprising both cabbed and cabless variants of the system 100, selecting the appropriate configuration based on specific operational zones, weather exposure, and the anticipated frequency of manual intervention requirements.

As illustrated in FIG. 3, the present disclosure further contemplates that the cabless embodiment of the system 100 may be configured to support modular attachment points where temporary operator stations can be installed when manual control becomes desirable. In a preferred embodiment, these attachment points may accommodate portable control consoles that can be secured to the bed 110 or a designated mounting location, allowing an operator 300 to assume direct control during complex maneuvering situations or emergency scenarios. The modular approach can provide operational flexibility, enabling port facilities to adapt the system 100 configuration based on evolving operational demands without requiring permanent structural modifications. For example, a port experiencing a temporary surge in container volume during peak shipping season might attach portable control stations to cabless systems 100 to enable hybrid operation modes that combine autonomous navigation with human oversight at congested intersections. In some instances, the portable control console may include a simplified interface compared to the full control panel found in the cab 102, focusing on directional inputs and emergency stop functions while delegating scanning and routing decisions to the computing entity 710. Alternatively, the attachment points may be configured to accept auxiliary equipment such as supplemental lighting arrays, communication antennas, or additional sensor packages that enhance the system's capabilities for specialized applications within the port environment.

As illustrated in FIG. 4, the present disclosure describes a front orthogonal view of the scanning collar 120, which may serve as a component of the system 100 for scanning shipping containers 200. In a preferred embodiment, the scanning collar 120 comprises a horseshoe-shaped collar frame 122 that can house multiple integrated scanning components configured to gather data from containers during transport operations. The horseshoe configuration may allow the scanning collar 120 to surround three sides of a shipping container 200 while leaving one side open for container loading and unloading procedures. In another preferred embodiment, the collar frame 122 may be rectangular to match the standard shape of a shipping container, thereby providing uniform sensor coverage across the container surfaces. In some preferred embodiments, the collar frame 122 can be semicircular and may lack a straight face, which can be advantageous for scanning containers with non-standard geometries or for reducing material costs in manufacturing. The scanning components may be distributed within the collar frame 122 such that each component can gather data from a substantial portion of the shipping container 200 during a scan 130, enabling comprehensive inspection without repositioning the container.

In a preferred embodiment, attachment ports 121 may be located at the base of each side of the collar frame 122 to facilitate secure mounting of the scanning collar 120 to the vehicle bed. These attachment ports 121 can allow the scanning collar 120 to be securely mounted to the vehicle bed, which may help ensure stability during scanning operations and transportation across uneven port surfaces. In another preferred embodiment, the attachment ports 121 may be located on both the interior and exterior faces of the collar frame 122, providing multiple mounting options that can accommodate different bed configurations. The attachment ports 121 can be configured to fit within collar grooves 116, which may guide the scanning collar 120 along a predetermined path during scanning operations. In some instances, while positioned within the collar grooves 116, the attachment ports 121 may serve as the location upon which force is exerted to move the scanning collar 120 down the length of the shipping container 200 during a scan 130. In some preferred embodiments, the attachment ports 121 can comprise electrical and electronic components appropriate to provide power to the scanning components and connect them to the computing entity 710, thereby enabling data transmission and coordinated sensor activation.

In some preferred embodiments, collar drive motors may be configured to enable the scanning collar 120 to traverse the length of the vehicle's bed during inspection operations. The present disclosure contemplates various types of devices that can serve as collar drive motors, each offering distinct characteristics and advantages that may be tailored to the specific needs of the system 100. The choice of collar drive motor can depend on various factors, including the desired precision of movement, load capacity requirements, environmental conditions encountered in port settings, and integration with the vehicle's existing propulsion and control systems. For instance, a port operating in a humid coastal environment may benefit from drive motors with enhanced corrosion resistance, while a facility handling oversized containers may prioritize motors with higher torque ratings. By selecting the appropriate drive motor, the system 100 can achieve efficient and reliable operation, enabling the scanning collar 120 to perform its function of inspecting shipping containers 200 with accuracy and thoroughness. Alternatively, multiple drive motor types may be combined within a single system to leverage the advantages of each technology for different operational phases.

In a preferred embodiment of the system 100, an electric linear actuator may be employed as the collar drive motor, offering an effective solution for the precise linear motion control that can be beneficial in scanning operations. Electric linear actuators can provide smooth and accurate movement along a straight path, which may help maintain the sensors within the scanning collar 120 at a consistent distance and orientation relative to the shipping container 200. This precision can help ensure that the data collected during the scanning process is reliable and comprehensive, allowing for the accurate detection of potential threats or anomalies within the container. For instance, maintaining a consistent sensor-to-container distance of approximately 15 centimeters throughout the scan may improve X-ray image clarity and reduce distortion artifacts. The use of electric linear actuators may be further enhanced by their ease of integration with the system's control electronics, as these actuators can be seamlessly coordinated with other components of the vehicle such as navigation systems and data processing units. In some instances, this integration can be facilitated by the actuator's compatibility with standard electronic control interfaces, which may allow for straightforward programming and adjustment of movement parameters to optimize scanning routines.

Electric linear actuators may be known for their reliability and durability, making them well-suited for the demanding conditions often encountered in port environments where equipment can be exposed to salt spray, temperature variations, and continuous operation cycles. These actuators can be capable of withstanding repeated use without significant wear, which may help ensure consistent performance over extended operational periods spanning months or years. This robustness can be complemented by their relatively low maintenance requirements, which may reduce operational downtime and associated costs for port operators managing large fleets of scanning vehicles. In another preferred embodiment, electric linear actuators may be more energy-efficient than other types of drive systems, contributing to the overall sustainability of the system 100 and potentially extending battery life in electrically powered configurations. For instance, regenerative braking features in some electric linear actuators can recover energy during deceleration phases of the scanning collar's movement cycle. The implementation of electric linear actuators as collar drive motors in the system 100 can represent a strategic choice that may enhance the precision, integration, and reliability of the scanning operations while supporting the broader goals of port security and operational efficiency.

In another preferred embodiment of the system 100, stepper motors may be utilized as the collar drive motor, offering a robust and precise solution for the movement of the scanning collar 120 along the vehicle's bed. Stepper motors can be renowned for their ability to provide exact control over rotational movement, which may be effectively harnessed to drive the scanning collar 120 along a predetermined path. By pairing stepper motors with lead screws or belt drive systems, the rotational motion generated by the motor can be seamlessly converted into linear motion suitable for scanning operations. This conversion may be beneficial for the scanning operations, as it can help ensure that the collar moves smoothly and accurately along a predetermined path while maintaining the optimal positioning of sensors relative to the shipping container 200. For instance, a lead screw with a pitch of 5 millimeters per revolution can provide fine positioning control when paired with a stepper motor capable of 200 steps per revolution. The precision offered by stepper motors can be particularly beneficial in scanning applications, where even slight deviations in sensor positioning may impact the quality and reliability of the data collected from the container's contents.

Stepper motors may allow for incremental movement, enabling the scanning collar 120 to stop at precise intervals, which can be useful for detailed inspections of specific container regions that warrant closer examination. This level of control can help ensure that the system 100 performs comprehensive scans, detecting potential threats or anomalies with high accuracy across the entire length of the shipping container 200. In some preferred embodiments, stepper motors can be highly reliable and may operate effectively in a wide range of environmental conditions, making them a suitable choice for port operations where durability is a consideration. Ports often present challenging environments, with exposure to moisture from sea spray, temperature fluctuations between day and night operations, and mechanical stress from continuous loading and unloading activities. Stepper motors may be designed to withstand these conditions, which can help ensure consistent performance and longevity over thousands of scanning cycles. Their robust construction and minimal maintenance requirements can contribute to reduced operational downtime and lower maintenance costs, potentially enhancing the overall efficiency of the system 100 in high-throughput port facilities.

The integration of stepper motors into the control system of the system 100 may be relatively straightforward, allowing for seamless coordination with other vehicle components such as the computing entity 710 and navigation cameras 112. This compatibility can help ensure that the stepper motors may be easily programmed and adjusted to meet the specific requirements of the scanning operations, providing flexibility and adaptability in various operational scenarios encountered at different port facilities. In a preferred embodiment, the stepper motors can be controlled using pulse-width modulation signals from the computing entity 710, enabling precise speed and position control during scanning operations. For instance, the computing entity 710 may command the stepper motor to advance the scanning collar 120 at a rate of 10 centimeters per second during routine scans, while slowing to 2 centimeters per second when detailed inspection of a flagged region is warranted. In some instances, the stepper motors may incorporate encoder feedback systems that can verify actual position against commanded position, enabling closed-loop control for enhanced accuracy. The use of stepper motors as collar drive motors in the system 100 can represent a strategic choice that combines precision, reliability, and durability, supporting the system's ability to perform effective and efficient container inspections.

In some preferred embodiments, servo motors may alternatively be employed as collar drive motors, offering another option for precise motion control of the scanning collar 120. Servo motors can provide continuous position feedback through integrated encoders, which may enable the computing entity 710 to monitor and adjust collar position in real-time during scanning operations. The present disclosure contemplates that servo motors may offer advantages in applications where variable speed control and rapid acceleration or deceleration are desired, such as when the scanning collar 120 needs to quickly reposition to rescan a suspicious area identified during initial inspection. In another preferred embodiment, hydraulic actuators may be utilized as collar drive motors in configurations where high force output is beneficial, such as when the scanning collar 120 carries a heavy complement of sensors or when operating in environments with significant vibration. Pneumatic actuators can optionally be employed in applications where clean operation is preferred, as these systems may avoid the potential for hydraulic fluid leaks that could contaminate cargo or port surfaces. The selection among these various drive motor technologies can depend on the specific operational requirements, environmental conditions, and maintenance capabilities of the port facility where the system 100 is deployed.

As illustrated in FIG. 4, a highly preferred scanning component for the scanning collar 120 may be an X-ray scanner 123, which can be positioned at the apex of the arch of the scanning collar 120 to provide optimal coverage of the shipping container 200. In a preferred embodiment, this X-ray scanner 123 may be used to generate images of the contents inside shipping containers 200, potentially revealing hidden compartments, concealed objects, or discrepancies between declared and actual cargo. The X-ray scanner 123 can operate by emitting X-ray radiation that penetrates the container walls and contents, with detectors on the opposite side of the collar frame 122 capturing the transmitted radiation to form an image. In another preferred embodiment, the scanner 123 may use other types of ionizing radiation to scan the shipping container 200, such as gamma rays which may improve penetration through the metal exteriors of the shipping containers 200 and dense cargo materials. For instance, gamma ray scanning may be particularly useful for inspecting containers loaded with heavy machinery or metal components that could attenuate X-ray beams. Alternatively, the scanning collar 120 may incorporate beta or positron scanners as alternatives or complements to the X-ray or gamma ray scanners, depending on the specific detection requirements of the port facility.

Beta scanners may offer advantages in detecting certain types of materials, particularly those with lower atomic numbers such as organic compounds and plastics that may be difficult to distinguish using conventional X-ray imaging. The use of beta radiation may allow for improved sensitivity in identifying organic materials, which can be beneficial for detecting contraband such as drugs concealed within legitimate cargo or explosive precursors hidden among consumer goods. In some instances, positron scanners may provide unique capabilities for container inspection by detecting subtle changes in material composition that might not be apparent with other scanning methods. This can potentially enhance the ability to identify specific chemical signatures associated with various substances of interest, such as distinguishing between different types of fertilizers that may have legitimate agricultural uses or potential explosive applications. The integration of beta or positron scanners into the scanning collar 120 may involve modifications to the collar frame 122 to accommodate the different sensor configurations and shielding requirements. In a preferred embodiment, these scanners may be positioned alongside or in place of the X-ray scanner 123, depending on the specific scanning requirements, space constraints within the collar frame 122, and the types of cargo most frequently processed at the port facility.

The use of beta or positron scanners may also involve adjustments to the data processing algorithms within the computing entity 710, as these scanners can generate different types of data outputs compared to X-ray or gamma ray scanners that may involve specialized interpretation methods. In another preferred embodiment, the selection of beta or positron scanners may influence the power requirements and overall energy consumption of the system 100, potentially affecting operational range or duration between refueling or recharging cycles. In some preferred embodiments, these alternative scanning technologies can offer improved energy efficiency for certain applications, which may extend the operational capabilities of the system 100 during extended scanning sessions. However, beta or positron scanners may prove less effective against containers composed primarily of metal, potentially limiting their use to shipping containers composed of plastic, fiberglass, or other nonmetallic materials such as those used for certain refrigerated cargo applications. For instance, insulated containers used for pharmaceutical transport may be more amenable to beta scanning than standard steel intermodal containers. The present disclosure contemplates that port operators may select scanning technologies based on the predominant cargo types handled at their facilities, with some installations featuring interchangeable scanner modules that can be swapped based on operational needs.

In a preferred embodiment, the scanning collar 120 may comprise one or more VOC detectors 124 configured to detect and identify volatile organic compounds emanating from shipping containers 200. These VOC (Volatile Organic Compound) detectors 124 can be utilized to detect and identify volatile organic compounds, which are organic chemicals that have a high vapor pressure at ordinary room temperature and can easily evaporate or sublimate into the surrounding air. This property may allow VOCs to be detectable even when contained within a sealed shipping container 200, as trace amounts can escape through seals, ventilation openings, or micro-perforations in container walls. In another preferred embodiment, the VOC detector 124 can enable rapid and specific safety determinations by analyzing the chemical composition of detected vapors against known threat signatures. For instance, many industrial chemicals, solvents, and fuels emit characteristic VOCs that can alert operators to the presence of potentially dangerous substances requiring special handling, explosion risk mitigation, or secondary containment measures. Similarly, certain illicit drugs and their precursors may emit specific VOCs, and by detecting these chemical signatures, the system 100 can flag containers that may contain narcotics or materials used in their production for further inspection by law enforcement personnel.

Unexpected VOC readings may indicate leaks or damage to a container's contents, allowing for early intervention to prevent environmental contamination or safety hazards that could affect port workers or surrounding communities. In a preferred embodiment, the VOC detectors 124 can employ advanced sensing technologies such as photoionization detectors (PIDs), metal oxide semiconductors, or gas chromatography coupled with mass spectrometry (GC-MS) for comprehensive chemical analysis. These technologies may allow for real-time, non-invasive detection of a wide range of organic compounds at very low concentrations, potentially in the parts-per-billion range for certain target analytes. As the scanning collar 120 traverses the length of the shipping container 200 during a scan 130, the VOC detectors 124 can continuously sample the air around the container to build a spatial profile of detected compounds. In some instances, any detected VOCs may be analyzed and compared against a database of known chemical signatures stored on the computing entity 710, enabling automated identification of potential threats. The VOC profile detected can be compared against the declared contents of the container as listed in shipping manifests, helping to identify discrepancies that may warrant further investigation by customs officials or security personnel.

In some preferred embodiments, the data from VOC detectors 124 may be integrated with information from other sensors in the scanning collar 120, such as the X-ray scanner 123 and radiation detectors 127, to provide a comprehensive risk assessment of the container's contents. This integrated data approach can allow for the rapid and efficient screening of containers for a wide range of potential threats without the need to open or physically enter the container, thereby maintaining the integrity of the cargo while enhancing overall port security. For instance, elevated VOC readings combined with unusual density patterns in X-ray imagery may indicate the presence of concealed liquid contraband within otherwise legitimate cargo. In a preferred embodiment, the scanning collar 120 may further comprise thermal cameras 125 configured to detect heat signatures within the containers during scanning operations. These thermal cameras 125 can be used to detect heat signatures within the containers, allowing the thermal cameras 125 to create a heat map of the container's contents without the need to open or physically enter the container. The heat maps generated by the thermal cameras 125 can identify various points of interest for inspection, including temperature anomalies that may indicate the presence of living organisms, active chemical reactions, or malfunctioning equipment.

In another preferred embodiment, even in sealed containers, the body heat of humans or animals can create a distinct thermal signature that may be easily distinguished from surrounding cargo by the thermal cameras 125. This feature can enhance the system's capability to address humanitarian concerns and comply with international regulations on human trafficking prevention, as individuals concealed within containers may be detected through their thermal emissions even when visually obscured by cargo. Similarly, hazardous chemical reactions often generate heat as a byproduct, and the thermal cameras 125 can identify unexpected hot spots within a container that may indicate ongoing chemical processes or thermal runaway conditions. This capability may be useful for detecting unstable or improperly stored chemicals that could pose a risk during transport or handling, such as oxidizers stored near organic materials or batteries experiencing internal short circuits. Early detection of such reactions can potentially prevent accidents or explosions that could endanger port workers and damage surrounding infrastructure. In some instances, the thermal cameras 125 may operate in multiple wavelength bands to distinguish between different heat sources and improve the accuracy of temperature measurements across varying container materials.

As demand for electronic goods continues to grow, thermal cameras 125 can serve to monitor incoming devices for potential safety hazards related to electrical malfunctions or battery defects. Faulty electronic devices may exhibit unusual heat patterns due to short circuits, resistive heating, or other malfunctions that could pose fire risks during storage or transport. In a preferred embodiment, the thermal cameras 125 can identify these anomalies, potentially preventing fires or other hazards associated with defective electronics before containers are moved into warehouse storage areas. This capability may be particularly relevant for containers transporting consumer electronics, lithium-ion batteries, or other electrical goods that have been associated with thermal incidents during shipping. Similarly, frozen or refrigerated goods requiring consistent low temperatures may be checked using the thermal cameras 125 to ensure no disruption of the refrigeration has occurred during transit, which could affect food safety or pharmaceutical efficacy. By contrast, active electronic devices, such as those found in smuggled communication equipment or unauthorized tracking devices, often emit heat during operation, and the thermal cameras 125 can detect these heat signatures to potentially uncover hidden electronic systems that may be used for illicit purposes such as cargo theft coordination or smuggling network communications.

In a preferred embodiment, spectroscopic analyzers 126 may be mounted in the scanning collar 120 to provide detailed chemical composition analysis of materials within shipping containers 200. Spectroscopic analyzers can utilize the principles of spectroscopy, which involves the study of how matter interacts with electromagnetic radiation across various wavelength ranges. These analyzers 126 may be employed to identify the chemical composition of materials within the container by analyzing the spectrum of light they emit, absorb, or scatter when illuminated by probe radiation. The spectroscopic analyzers 126 can employ various spectroscopic techniques, such as Raman spectroscopy, near-infrared (NIR) spectroscopy, or laser-induced breakdown spectroscopy (LIBS), each offering unique advantages in identifying different types of materials. For instance, Raman spectroscopy may be particularly effective in detecting organic compounds and can distinguish between different molecular structures, making it useful for identifying drugs, explosives, or counterfeit goods with specific chemical signatures. NIR spectroscopy can penetrate packaging materials and may be used for rapid, non-destructive analysis of bulk materials such as agricultural products, textiles, or pharmaceutical ingredients.

LIBS, on the other hand, can detect trace amounts of elements, which may be valuable for identifying hazardous materials, verifying the composition of declared goods, or detecting the presence of heavy metals in consumer products. In another preferred embodiment, the data collected by the spectroscopic analyzers 126 may be processed by the computing entity 710, which can compare the spectral signatures against a database of known materials to enable rapid identification. This comparison can allow for rapid identification of substances that may pose security risks, such as explosives, narcotics, or hazardous chemicals that are prohibited or restricted in international shipping. Additionally, the spectroscopic analysis can verify the declared contents of the shipping container 200, helping to detect discrepancies that may indicate smuggling, mislabeling of goods, or customs fraud. In some preferred embodiments, when combined with data from other sensors like the X-ray scanner 123, radiation detectors 127, and VOC detectors 124, the spectroscopic analysis can provide a comprehensive profile of the container's contents. This multi-sensor approach may significantly improve the accuracy of threat detection and can reduce the likelihood of false positives, thereby streamlining the container inspection process and enhancing port security while minimizing delays to legitimate commerce.

The scanning collar 120 may further comprise one or more radiation detectors 127 configured to identify the presence of radioactive materials within the shipping containers 200. In a preferred embodiment, these detectors may be used to identify the presence of radioactive materials that could pose health risks to port workers or indicate the illicit transport of nuclear materials. These detectors can be designed to measure ionizing radiation, which may be emitted by various radioactive isotopes including naturally occurring materials, medical isotopes, industrial sources, and potentially weapons-grade materials. The detectors may utilize different technologies such as scintillation crystals, Geiger-Müller tubes, or semiconductor-based sensors to detect and quantify radiation levels with varying degrees of sensitivity and energy resolution. In another preferred embodiment, as the scanning collar 120 traverses the length of the shipping container 200 during a scan 130, the radiation detectors 127 can continuously monitor for gamma rays and neutrons, which are common forms of radiation emitted by radioactive materials. The data collected by these detectors may be processed in real-time by the computing entity 710, which can compare the detected radiation levels against background radiation measurements and predetermined thresholds for various isotopes to determine whether elevated readings warrant further investigation.

In some preferred embodiments, the radiation detection capability may be particularly valuable for detecting illicit transportation of radioactive materials, including those that could potentially be used in dirty bombs or other radiological dispersal devices. The radiation detectors 127 can also identify legitimate shipments of radioactive materials that may involve special handling or documentation requirements, such as medical isotopes used in diagnostic imaging or cancer treatment, industrial radiography sources, or fuel assemblies for nuclear power generation. For instance, a container carrying cobalt-60 sources for medical sterilization equipment would trigger radiation alerts that could be verified against shipping documentation to confirm legitimate transport. In a preferred embodiment, the radiation detectors 127 may be configured to distinguish between different types of radiation and estimate the energy spectrum of detected emissions, which can help identify the specific isotopes present within a container. This isotope identification capability may allow port security personnel to differentiate between benign sources of radiation, such as naturally occurring radioactive materials in ceramic tiles or granite countertops, and potentially threatening materials that warrant immediate response. The integration of radiation detection with other scanning modalities in the scanning collar 120 can provide a comprehensive security screening capability that addresses multiple threat vectors while maintaining efficient throughput of legitimate cargo through the port facility.

As illustrated in FIG. 5, the present disclosure describes a top orthogonal view of the bed 110 of the automated guided system 100, which may serve as the primary platform for transporting shipping containers within port environments. The bed 110 can house various components that facilitate the system's operation and container handling capabilities, including sensors, attachment mechanisms, and guidance features. In a preferred embodiment, the bed 110 may be configured to accommodate standard shipping container dimensions, such as twenty-foot equivalent units or forty-foot equivalent units, while providing a stable surface during both stationary and mobile operations. The structural design of the bed 110 can incorporate reinforced materials such as high-strength steel or aluminum alloys to withstand the substantial weight of loaded shipping containers. In some instances, the bed 110 may feature a textured or ribbed surface to enhance friction and prevent container slippage during transport. The overall dimensions of the bed 110 can be optimized to balance load capacity with maneuverability requirements in congested port areas.

In a preferred embodiment, the bed 110 may be equipped with four Mecanum wheels 104, which can be positioned at each corner of the undercarriage to provide stable and versatile mobility. These specialized wheels may enable omnidirectional movement, allowing the system 100 to maneuver precisely in tight spaces and navigate complex port environments with enhanced agility. The Mecanum wheels 104 can provide the ability to move sideways, diagonally, and rotate in place, which may enhance the system's efficiency in container handling operations where space constraints limit traditional forward-and-reverse movement patterns. In another preferred embodiment, each Mecanum wheel 104 may be independently driven by a dedicated motor, allowing for precise control over the system's trajectory and orientation. For instance, when approaching a container stack from an angle, the system 100 can adjust its position laterally without the need for multi-point turning maneuvers. The Mecanum wheel configuration may also facilitate parallel parking-style movements when positioning the system 100 beneath overhead cranes or alongside loading docks.

In a preferred embodiment, navigation cameras 112 may be mounted on multiple sides of the bed 110 to provide comprehensive visual coverage of the system's surroundings. These cameras can capture real-time video data that may be used for autonomous navigation, obstacle detection, and situational awareness during port operations. In another preferred embodiment, the data from these cameras may be processed by the system's computing entity 710 to guide its movements and assist in positioning for container pickup and delivery operations. The navigation cameras 112 can optionally include wide-angle lenses to maximize the field of view and reduce blind spots around the perimeter of the system 100. In some preferred embodiments, the data from these cameras may be provided to the operator 300 while they manually control the system 100, displaying feeds on monitors within the cab 102 or on a portable handset device. For instance, a rear-facing camera feed may assist an operator 300 in backing the system 100 into a narrow loading bay without direct line-of-sight visibility.

The present disclosure describes anchor loops 114 that may be distributed along the perimeter of the bed 110 to provide secure attachment points for cargo during transport. These loops can serve as connection points for straps, chains, or other fastening devices that may be used to ensure containers or other cargo remain stable and secure while the system 100 is in motion. In a preferred embodiment, the anchor loops 114 may be constructed from high-strength materials such as hardened steel or reinforced alloys to withstand the significant forces exerted during system movement and cargo shifting. The utility of these loops can be particularly apparent during sudden stops, which may occur due to emergency braking or collision avoidance maneuvers that generate substantial forward momentum in the cargo. Similarly, rapid changes in direction, such as sharp turns or evasive maneuvers, can create lateral forces that could potentially destabilize an unsecured load. In some instances, the anchor loops 114 and associated fastening systems may work together to counteract these forces, maintaining the cargo's position relative to the bed 110 throughout transport operations.

In another preferred embodiment, the additional security provided by strapping containers down may enable the system 100 to conduct scans 130 while in transit, thereby improving operational efficiency by combining transport and inspection functions. The anchor loops 114 can be positioned at regular intervals along the bed's perimeter to accommodate various container sizes and securing configurations. For instance, a twenty-foot container may utilize a different subset of anchor loops 114 than a forty-foot container, allowing operators to select appropriate attachment points based on cargo dimensions. In some preferred embodiments, the anchor loops 114 may feature quick-release mechanisms that allow for rapid attachment and detachment of securing devices, reducing loading and unloading times. The loops can optionally be recessed into the bed surface when not in use to prevent interference with container placement or scanning collar 120 movement. Alternatively, the anchor loops 114 may be designed with swivel capabilities to accommodate securing straps approaching from various angles.

In some preferred embodiments, automated clamping devices may be strategically positioned at the four corners of the vehicle's bed 110 to secure shipping containers firmly in place during transport. These devices can be designed to engage automatically once the container is correctly positioned on the bed 110, ensuring stability and safety throughout the vehicle's operations. The clamping devices may be electrically actuated, with their engagement triggered by container positioning sensors that detect the exact alignment and placement of the container. Upon confirmation of the container's proper positioning, the sensors can trigger the clamping devices to activate, securely fastening the container to the bed 110 without manual intervention. This automated process may enhance the safety of the transport operation by preventing container movement during transit while also streamlining the loading and unloading process. For instance, a container lowered by an overhead gantry crane may be automatically secured within seconds of placement, allowing the crane to proceed to the next container without waiting for manual clamping procedures.

In a preferred embodiment, a container sensor 115 may be positioned in the central area of the bed 110 to detect the presence and proper positioning of shipping containers. As illustrated in FIG. 5, the container sensor 115 can employ various technologies to achieve reliable container detection and positioning verification. For instance, pressure sensors may measure the weight distribution on the bed 110, indicating not merely the presence of a container but also providing data on its weight and balance characteristics. Furthermore, optical sensors, such as cameras or laser scanners, can visually confirm the container's presence and assess its positioning relative to predefined markers on the bed 110. Similarly, proximity sensors utilizing technologies like ultrasonic or infrared detection can identify the container's edges and corners, helping to ensure proper alignment within the bed's boundaries. In another preferred embodiment, the data from the container sensor 115 may be processed by the computing entity 710, which can use this information to trigger subsequent actions in the operational sequence.

In some preferred embodiments, once the container sensor 115 confirms proper container placement, the system 100 may automatically initiate the scanning process by activating the scanning collar 120. Proper alignment can help ensure that the scanning collar 120 traverses the entire length of the container without obstruction, allowing for comprehensive data collection from the integrated sensors. The container sensor 115 may optionally include redundant detection mechanisms to provide verification of container presence through multiple independent measurements. For instance, a combination of weight-based detection and optical confirmation can reduce the likelihood of false positive or false negative readings. In some instances, the container sensor 115 may be configured to detect partial container placement, alerting the operator 300 or computing entity 710 to reposition the container before proceeding with transport or scanning operations. The sensor data can also be logged for record-keeping purposes, creating a timestamped record of container loading events for port management systems.

In some preferred embodiments, a block module may be configured to house a comprehensive sensor processing package, which can include the equipment for high energy scanning devices. The placement of this module on the opposite side of the platform from the operator's cab 102 may help ensure a balanced distribution of weight and space, optimizing the vehicle's stability and maneuverability during operations. The block module can be approximately the same size as an operator's cab 102, allowing it to integrate into the vehicle's overall design without compromising its compactness or functionality. This module may serve as a centralized hub for advanced scanning technologies, enabling the system 100 to perform thorough and efficient inspections of shipping containers. The inclusion of high energy scanning devices within the module can enhance the vehicle's capability to detect a wide range of potential threats, including those that may be obscured by dense or layered materials within the containers. For instance, contraband concealed within legitimate cargo shipments may be identified through penetrating X-ray or gamma ray imaging that reveals density anomalies within the container contents.

In a preferred embodiment, high energy scanning devices, such as those utilizing X-rays or gamma rays, may be equipped with specialized equipment to generate and process the radiation safely and effectively. The block module can include power supplies, cooling systems, and shielding components that support the operation of these devices within the mobile platform environment. The sensor processing package within the module may be designed to handle the complex data generated by high energy scans, helping to ensure that the information is accurately interpreted and relayed to the vehicle's control systems. Accordingly, in some preferred embodiments, a computing system may be configured to process complex scanning data and may be operably connected to the high energy scanning devices. The block module can optionally include environmental controls to maintain optimal operating temperatures for sensitive electronic components during extended scanning operations. Alternatively, the module may incorporate modular component bays that allow for the installation of different sensor configurations based on specific port security requirements.

In a preferred embodiment, a wiring system may be configured to connect a power source to the various electronic components integral to the operation of the system 100. This wiring system can serve as the backbone of the vehicle's electrical infrastructure, helping to ensure that power is efficiently distributed to sensors, motors, communication interfaces, and control systems. The wiring system may be engineered to withstand the challenging environments often encountered in port operations, utilizing materials resistant to wear, corrosion, and environmental stressors such as moisture and temperature fluctuations. In another preferred embodiment, the wiring system may be organized to facilitate maintenance and troubleshooting procedures. In some preferred embodiments, clearly labeled and color-coded wires can allow for straightforward identification and access, enabling technicians to address issues that may arise during routine maintenance or emergency repairs. The system can also be designed with modularity in mind, allowing for the integration of additional components or upgrades as operational demands evolve.

In some preferred embodiments, connectors may be used to establish secure and reliable electrical connections between the wiring system and the various components of the system 100. These connectors can be designed to facilitate attachment and detachment, allowing for installation and maintenance procedures to be completed efficiently. For instance, connectors may be used with the drive system to help ensure that the motors receive consistent power, enabling precise control over the vehicle's movement patterns. Connectors can also be used to link sensors to the wiring system, helping to ensure that they are powered and capable of transmitting data to the control systems. In another preferred embodiment, rectifiers may be used in systems where alternating current from the power source needs to be converted into direct current for use by the system's electronic components. In the drive system, rectifiers can convert AC to DC, providing the motors with stable power for smooth and reliable operation, while for sensors, rectifiers may help ensure that the power supplied is consistent and of the correct type for accurate data collection and transmission.

As illustrated in FIG. 5, collar grooves 116 may be located on the sides of the bed 110 to accommodate the movement of the scanning collar 120 along the length of the bed. These grooves can provide a track or guide system that allows the scanning collar 120 to traverse the entire length of a container during scanning operations, helping to ensure comprehensive coverage and consistent positioning of the scanning equipment relative to the container. In another preferred embodiment, the collar grooves 116 may be located on the lateral faces of the bed 110, while in still another preferred embodiment, the collar grooves 116 may be located on the underside of the bed 110. The collar grooves 116 can be engineered to withstand the weight and forces exerted by the scanning collar 120 as it moves along the bed's length. They may be constructed from durable materials such as hardened steel or reinforced polymers to provide longevity and resistance to wear from repeated use. The grooves can optionally incorporate a low-friction surface or rollers to facilitate the smooth movement of the scanning collar 120 during scanning operations.

In a preferred embodiment, the depth and width of the collar grooves 116 may be calibrated to match the dimensions of the attachment ports 121 on the scanning collar 120. This precise fit can help ensure that the scanning collar 120 remains stable and properly aligned throughout its traversal of the container during scanning operations. The grooves may also include built-in locking mechanisms or safety features to prevent the scanning collar 120 from disengaging during operation or in the event of power loss. By providing a consistent track for the scanning collar 120, the collar grooves 116 can enable the system 100 to maintain uniform scanning coverage of the entire container. This consistency may contribute to the accuracy and reliability of the threat detection system during port security operations. The grooves can help ensure that sensors integrated into the scanning collar 120—including X-ray scanner 123, thermal camera 125, radiation detector 127, VOC detector 124, and spectroscopic analyzer 126—maintain their optimal position relative to the container surface throughout the scanning process.

In another preferred embodiment, the design of the collar grooves 116 may incorporate features to accommodate variations in container sizes and shapes that the system 100 may encounter during port operations. For instance, the collar grooves 116 can include adjustable stops or sensors that detect the end of a container, allowing the system 100 to adapt its scanning range accordingly based on the specific container dimensions. This flexibility may enhance the system's ability to handle a diverse range of container types efficiently without manual reconfiguration. Furthermore, the collar grooves 116 may be equipped with cleaning and maintenance features to help ensure reliable operation in various port environments. These features can include drainage channels to prevent water accumulation from rain or spray, or integrated cleaning mechanisms to remove debris that might interfere with the scanning collar's movement. In some instances, the collar grooves 116 may incorporate wear indicators that alert maintenance personnel when groove surfaces approach replacement thresholds, allowing for proactive maintenance scheduling.

The present disclosure describes collar grooves 116 that may be configured to support various scanning collar 120 movement patterns beyond simple linear traversal. In some preferred embodiments, the grooves can accommodate variable-speed movement of the scanning collar 120, allowing for slower traversal speeds when detailed scanning is desired and faster speeds for preliminary assessments. The collar grooves 116 may optionally include position encoding features that allow the computing entity 710 to track the precise location of the scanning collar 120 at any point during its traversal. This positional data can be correlated with sensor readings to create detailed spatial maps of detected anomalies within the container. For instance, if elevated radiation levels are detected at a specific point during the scan, the system 100 can record the exact position along the container where the reading occurred. In another preferred embodiment, the collar grooves 116 may support bidirectional movement of the scanning collar 120, allowing for multiple passes over areas of interest identified during an initial scan.

As illustrated in FIG. 6, the present disclosure describes a bottom orthogonal view of the bed 110, revealing the arrangement of components beneath the vehicle platform that may facilitate propulsion and maneuverability. In a preferred embodiment, each Mecanum wheel 104 can be driven by a dedicated engine 108, with four engines 108 total being distributed near the corners of the bed 110 to provide independent control of each wheel. This configuration may allow for precise omnidirectional movement by enabling differential speed and direction control across the wheel assemblies. In another preferred embodiment, a single engine 108 may control two Mecanum wheels 104 positioned on the same side of the vehicle, while a separate engine 108 controls the remaining two wheels on the opposite side. In some instances, this dual-engine arrangement can reduce mechanical complexity while maintaining adequate maneuverability for port operations where lateral movement between container stacks is frequently performed. In yet another preferred embodiment, a single engine 108 may be configured to control all four Mecanum wheels 104 through a differential transmission system that distributes power appropriately to each wheel based on steering inputs.

In some preferred embodiments, the engines 108 may provide the power and torque suitable for driving the Mecanum wheels 104, thereby enabling the system's movement and container transportation capabilities across various port surfaces. The present disclosure contemplates that any embodiment involving Mecanum wheels 104 can maintain the ability to operate each wheel individually or in coordinated groups to help ensure suitable mobility of the system 100. For instance, when navigating around a stationary obstacle such as a parked forklift, the system 100 may engage individual wheel control to execute a precise lateral shift without changing the vehicle's orientation. Alternatively, during high-speed transit along open corridors within the port, the wheels may operate in synchronized forward motion to maximize efficiency and stability. In a preferred embodiment, the computing entity 710 may coordinate the engine outputs to achieve smooth transitions between different movement modes based on navigation requirements. The engine configuration can be selected based on factors such as expected load capacity, operational terrain conditions, and maintenance accessibility preferences at a particular port facility.

The Mecanum wheels 104, sensors, and other electronic components of the system 100 may be operably connected to a power supply, which can be defined as any source of power that provides the system 100 with suitable energy for operation. In a preferred embodiment, the power supply may comprise a stationary power source that has been installed in a manner such that it is fastened in place, such as a charging station or docking port located at designated areas within the port facility. The stationary power source can be connected to the system 100 in a way such that DC power is supplied to the engines 108 and other electrical components during charging or stationary operations. In another preferred embodiment, the power supply may comprise a mobile power source, such as a battery pack, gas-powered generator, alternator, or fuel cell that travels with the vehicle. In some instances, the mobile power source may not need to be connected to external infrastructure but can be capable of connecting to the wiring system of the system 100 to provide power to the Mecanum wheels 104, sensors, and other electronic components connected thereto. For instance, a lithium-ion battery pack may provide sufficient energy for several hours of continuous operation before requiring recharging at a designated station.

In another preferred embodiment, the system 100 may comprise multiple power supplies configured to supply power to the system 100 in different circumstances and operational scenarios. For instance, the system 100 may be directly plugged into a stationary power source during idle periods, which can provide power to the system 100 so long as the system does not move out of range of the stationary power source, while also being connected to a mobile power source for active transport operations. The mobile power source may provide power to the system 100 when the system 100 is not connected to a stationary power source or in situations where the stationary power source ceases to provide power to the system 100 due to grid interruptions or scheduled maintenance. In yet another preferred embodiment, a plurality of solar charging panels may be operably connected to a battery of the system 100, which can then supply power to the system either directly or via the wiring infrastructure of the system 100. This solar charging capability may be particularly advantageous in port environments with extended daylight hours and open operational areas where panels can receive adequate sunlight exposure. As such, the present disclosure contemplates that the system 100 may be configured to receive power in a variety of ways without departing from the inventive subject matter described herein.

In a preferred embodiment, as illustrated in FIG. 6, a fuel tank 118A may be centrally located on the underside of the bed 110 to provide balanced weight distribution during vehicle operation. This tank can store the fuel suitable for powering the engines 108, providing an onboard energy source for extended operation of the system 100 during lengthy transport routes or multiple consecutive scanning operations. In some preferred embodiments, the system 100 may comprise an electric engine powered by an electric power source, and a diesel generator can be configured to provide electricity when the electric power source can no longer provide power to the electric engine, wherein the fuel tank 118A contains diesel fuel used by the diesel generator. This hybrid configuration may allow the system 100 to operate primarily on electric power for reduced emissions while maintaining backup capability for extended operations. In another preferred embodiment, one or more batteries may be located in place of the fuel tank 118A, providing direct current to the system 100 when the electric power source can no longer provide power thereto. Optionally, the battery placement may be designed to facilitate quick-swap replacement procedures that minimize vehicle downtime during shift changes.

In some instances, fuel lines 118B may extend from the fuel tank 118A to the generator or directly to the engines 108 depending on the propulsion configuration selected for a particular implementation. In some preferred embodiments, the engines 108 may be operably connected to the fuel tank 118A via fuel lines 118B, wherein the fuel lines 118B can provide a pathway for fuel distribution from the fuel tank 118A to power the engines 108 that drive the Mecanum wheels 104. The fuel lines 118B may be constructed from materials resistant to corrosion and fuel degradation, such as reinforced rubber or braided stainless steel, to help ensure reliable fuel delivery over extended service periods. In still another preferred embodiment, each engine 108 may contain its own fuel tank 118A, which can allow for separate refueling measures and potentially reduce the risk of complete fuel system failure affecting vehicle operation. For instance, a port operating in remote locations with limited refueling infrastructure may prefer individual fuel tanks that can be filled independently using portable fuel containers. Alternatively, a centralized fuel tank configuration may be preferred in facilities with established fueling stations that can service the entire system 100 in a single refueling operation, thereby reducing maintenance time and improving operational efficiency.

As illustrated in FIG. 7, the present disclosure describes a system 700 that may be configured to operate the system 100 for scanning and transporting shipping containers within port environments. In a preferred embodiment, the system 700 comprises a computing entity 710 that can be integrated into the system 100 to coordinate various operational functions including navigation, scanning, and communication tasks. The computing entity 710 may comprise a processor 712 coupled to a non-transitory computer-readable medium 714 containing instructions for executing the methods and operations described herein. In some preferred embodiments, the computing entity 710 can be incorporated into the bed 110, which may provide a centralized location for processing data from the various sensors and subsystems distributed throughout the system 100. Alternatively, the computing entity 710 may be built into the control panel of the cab 102, allowing for direct integration with operator interfaces and display systems. In another preferred embodiment, the computing entity 710 can be operably connected to the control panel of the cab 102 through wired or wireless connections, enabling flexible placement of computing hardware while maintaining responsive control capabilities.

In a preferred embodiment, the processor 712 may be defined as logic circuitry that responds to and processes the basic instructions that drive the computing entity 710. The processor 712 can comprise various types of conventional processors or microprocessors that interpret and execute computer readable instructions stored within the non-transitory computer-readable medium 714. In some instances, the processor 712 may include multi-core architectures that can handle parallel processing tasks, such as simultaneously analyzing scan data from multiple sensors while managing navigation algorithms. The processor 712 can be configured to perform the operations disclosed herein based on instructions stored within the non-transitory computer-readable medium 714, including risk assessment calculations, path planning computations, and communication protocol management. In some preferred embodiments, the processor 712 may provide for coordination of other components of the computing entity 710, such as memory controllers, input/output interfaces, and peripheral device managers. For instance, when the scanning collar 120 completes a traversal of a shipping container 200, the processor 712 can coordinate the collection of data from the X-ray scanner 123, thermal camera 125, and radiation detector 127 while simultaneously preparing transmission packets for the communications interface 702.

In another preferred embodiment, a computer program may be tangibly embodied in the non-transitory computer-readable medium 714 to enable the various functions of the system 100. The computer program can contain instructions that, when executed by the processor 712, perform one or more steps that comprise a method, such as those methods described herein for scanning, sorting, and transporting shipping containers. In some instances, the non-transitory computer-readable medium 714 may comprise solid-state storage devices, magnetic storage media, or optical storage media depending on the storage capacity and access speed requirements of a particular implementation. The computer program embodied in the non-transitory computer-readable medium 714 can contain instructions for interpreting electronic signals received from the communications interface 702, enabling the system 100 to respond to commands from operators 300 or centralized port management systems. In some preferred embodiments, the aforementioned computer program may contain instructions for analyzing data received from sensors in the scanning collar 120, including pattern recognition algorithms for identifying suspicious materials or anomalous readings. Alternatively, hardwired circuitry may be used in place of or in combination with software instructions to implement processes consistent with the principles described herein, and implementations consistent with the present disclosure are not limited to any specific combination of hardware circuitry and software.

As illustrated in FIG. 7, the communications interface 702 may be configured to enable contact with computing devices and other electronic devices which are not operably connected to the computing entity 710. In a preferred embodiment, the communications interface 702 comprises a transmitter 702A and a receiver 702B that work together to facilitate bidirectional data exchange between the system 100 and external entities. These external entities can include centralized port management systems that coordinate container movements across multiple vehicles, remote monitoring stations where supervisors oversee fleet operations, local handsets for controlling the system 100, or mobile devices used by operators 300 in the field. In some preferred embodiments, the communications interface 702 may support multiple communication protocols simultaneously, allowing the system 100 to maintain connections with different types of devices and networks as operational conditions change. For instance, the system 100 may communicate with a port management server via cellular networks while simultaneously receiving control inputs from an operator's Bluetooth-enabled handset. The communications interface 702 can optionally include encryption capabilities to protect sensitive scan data and operational commands from unauthorized interception during transmission.

In a preferred embodiment, the transmitter 702A may be configured to send outgoing signals from the system 100 to various receiving devices and systems within the port environment. These signals can include status updates about the system's position, operational state, battery or fuel levels, or scan results from the scanning collar 120. In some instances, when the system 100 detects a potential threat during a container scan, the transmitter 702A can immediately send an alert to the appropriate personnel or systems, enabling rapid response to security concerns. The transmitter 702A may utilize various wireless communication protocols such as Bluetooth, Wi-Fi, cellular networks including 4G and 5G technologies, or dedicated short-range communications to help ensure reliable and secure data transmission across different operational scenarios. In another preferred embodiment, the transmitter 702A can be configured to broadcast periodic heartbeat signals that allow port management systems to track the location and operational status of multiple systems 100 operating simultaneously within the facility. For instance, a port operating twenty systems 100 may receive position updates from each vehicle every few seconds, enabling real-time visualization of fleet movements on a centralized display.

In some preferred embodiments, the receiver 702B may be configured to accept incoming signals from external sources that direct or modify the operation of the system 100. In addition to standard manual control of the system's 100 operation, these incoming signals can include new instructions for the system's route, updates to its scanning protocols, or emergency stop commands in case of detected hazards. The receiver 702B can be capable of processing multiple types of incoming data, from simple text-based commands to complex software updates that may enhance the system's operational capabilities over time. In a preferred embodiment, the receiver 702B may include signal filtering and validation mechanisms that help ensure incoming commands originate from authorized sources before execution. For instance, a command to disable the alarm 704 may be validated against a list of authorized operator credentials before the system 100 complies with the instruction. Together, the transmitter 702A and receiver 702B can form a bidirectional communication system that helps the system 100 remain in contact with its operational ecosystem throughout container handling operations.

As illustrated in FIG. 7, the present disclosure describes a system 700 that may comprise an alarm 704 for alerting personnel to various conditions detected during operation. In a preferred embodiment, the alarm 704 can be configured to alert operators 300, port personnel, and nearby individuals to potential hazards or situations detected during container scanning or system operation. The alarm 704 may comprise both audible and visual alert mechanisms that work independently or in combination depending on the nature and severity of the detected condition. In some instances, the audible component can include a siren, horn, or speaker system capable of emitting distinct tones or pre-recorded voice messages to indicate different types of alerts. The visual component may incorporate flashing lights, LED displays, or digital signage to provide visual cues about the nature of the alert, which can be particularly useful in noisy port environments where audible warnings may be difficult to hear. In another preferred embodiment, the alarm 704 can be positioned at multiple locations on the system 100 to help ensure visibility and audibility from various approach angles.

In some preferred embodiments, the alarm 704 may be configured to produce different types of alerts based on the severity and nature of the detected issue. For instance, a low-level alert indicating routine operational status might trigger a subtle visual indicator such as a slowly blinking amber light, while a high-level threat could activate both loud audible warnings and bright flashing red lights to maximize attention. The alarm 704 can also be integrated with the system's 100 communication system through the communications interface 702, allowing it to simultaneously trigger local warnings and send notifications to remote monitoring stations or security personnel. In a preferred embodiment, the alarm 704 may be activated automatically by the computing entity 710 in response to data received from the scanning collar 120 or other sensors on the system 100, such as when radiation levels exceed predetermined thresholds. Additionally, the alarm 704 can be manually triggered by operators 300 in emergency situations using controls within the cab 102 or through the local handset. Optionally, the alarm 704 may include configurable volume and intensity settings that can be adjusted based on time of day, proximity to noise-sensitive areas, or specific port regulations.

In another preferred embodiment, the alarm 704 may be powered by the system's main power system and can include a backup power source to help ensure functionality even in the event of a main power failure. The backup power source can comprise a dedicated battery pack or capacitor bank that maintains alarm functionality for a predetermined duration following loss of primary power. In some instances, the alarm 704 may include self-diagnostic capabilities that periodically test audible and visual components to verify operational readiness. For instance, the computing entity 710 can initiate a brief, low-volume test of the alarm 704 speaker during system startup to confirm proper function before beginning container handling operations. The present disclosure contemplates that the alarm 704 may be modular in design, allowing port operators to customize the types and configurations of alert mechanisms based on specific operational requirements or regulatory standards. Alternatively, the alarm 704 can be integrated with external alarm systems within the port facility, enabling coordinated emergency responses when high-risk containers are detected by the scanning collar 120.

As illustrated in FIG. 8, the present disclosure describes a method 800 comprising certain preferred method steps by which a self-driving vehicle may scan, sort, and transport shipping containers within a port environment. Step 805 may indicate the beginning of the method, serving as an initialization point for the scanning and sorting process. In step 810, a shipping container 200 can be placed upon the bed 110 by port equipment such as overhead cranes or straddle carriers. In a preferred embodiment, the shipping container 200 in its entirety may fit on the bed 110 without protruding from the end, which can help maintain balance and stability during transport operations. In another preferred embodiment, the shipping container 200 may be configured so that the scanning collar 120 traverses its length when completing a scan 130, enabling comprehensive data collection from the container's contents. In some instances, the shipping container 200 may be positioned so as not to block the scanning collar 120 or the collar grooves 116, thereby avoiding impediment to the progress of the scan.

During step 815, the container sensor 115 may be configured to detect the presence of the shipping container 200 on the bed 110. In a preferred embodiment, the container sensor 115 and its associated computing device can immediately trigger the progression to step 820 upon detecting the container's presence. In another preferred embodiment, the container sensor 115 and its associated computing device may send an alert to one or more devices indicating that a shipping container has been loaded on the bed 110. For instance, an operator 300 manually driving the system 100 might observe on the dashboard an indicator confirming that the bed is loaded with cargo. Alternatively, an operator 300 operating the system 100 via a Bluetooth-enabled local handset might receive a visual or audible notification that the bed has been loaded and is ready for scanning. In some preferred embodiments, the container sensor 115 may utilize pressure-based detection, optical recognition, or a combination of sensing modalities to confirm container placement before proceeding with subsequent method steps.

In step 820, the system 100 may conduct a scan 130 to gather risk data from the shipping container 200. In a preferred embodiment, the sensors integrated within the scanning collar 120 can be responsible for gathering risk data as the collar traverses the length of the container. In another preferred embodiment, this risk data may be gathered from one or more of the sensors including the X-ray scanner 123, thermal camera 125, radiation detector 127, VOC detector 124, and spectroscopic analyzer 126 as the scanning collar 120 moves along the bed 110. Risk data may comprise one or more of X-ray or gamma images revealing internal container structures, thermal images indicating temperature variations, radiation levels suggesting the presence of radioactive materials, concentrations of volatile organic compounds that may indicate explosives or narcotics, and spectroscopic data identifying chemical compositions. In some preferred embodiments, every sensor may collect risk data during the first traversal of the scanning collar 120 to maximize data acquisition efficiency. Alternatively, a subset of sensors may collect risk data during the first traversal of the scanning collar 120, and the scan may comprise further traversals that collect risk data from the previously unused sensors until the system 100 has collected sufficient risk data to proceed to branching step 825.

In branching step 825, the system 100 may make a determination as to the risk level of the contents of the shipping container 200. This determination can involve human analysis, algorithmic sorting, or a combination of both approaches depending on the nature of the detected data. For instance, algorithmic analysis may process quantitative data from various sensors, including the radiation detector 127, VOC detector 124, and spectroscopic analyzer 126, more rapidly than a human operator can review it manually. This automated evaluation can allow for rapid identification of chemical, biological, radiological, and nuclear threats, as well as contraband materials that may pose security concerns. In a preferred embodiment, elevated levels of radiation detected by the integrated sensors may trigger an immediate high-risk classification that prompts additional safety protocols. Similarly, the presence of specific volatile organic compounds associated with explosives or controlled substances could result in a medium to high-risk designation warranting further investigation.

In some preferred embodiments, the spectroscopic data analysis can identify the chemical composition of materials within the container, flagging substances that match known threat profiles stored in reference databases. X-ray and thermal imaging data, which may benefit from nuanced interpretation, can be reviewed by trained security personnel who possess expertise in identifying anomalous patterns. These images may reveal hidden compartments within the container structure, unusual density patterns suggesting concealed items, or heat signatures that could indicate the presence of living beings or active electronic devices within the container. In some instances, the computing entity 710 may be configured to apply machine learning algorithms that have been trained on historical scan data to improve threat detection accuracy over time. The combination of automated analysis and human oversight can provide a layered approach to risk assessment that balances speed with thoroughness. Optionally, the system 100 may store scan results and risk determinations for later review, audit purposes, or training of detection algorithms.

Based on the determination made by the system 100 and the operator 300, the method 800 may proceed to one of step 840 or step 830 depending on the assessed risk level. If the determination indicates that the shipping container 200 presents a high or medium-risk, the method may proceed to step 840 for additional safety protocols. If the determination indicates that the shipping container 200 presents a low or no-risk, the method may proceed to step 830 for standard processing. In step 830, the system 100 can transport the shipping container 200 to a designated sorting zone within the port facility. In a preferred embodiment, the designated sorting zone may be a predetermined location wherein shipping containers 200 without dangerous materials can be inspected, transferred to trucks, loaded onto rail cars, or otherwise directed to their next destination. In another preferred embodiment, the system 100 may continue to transport the shipping container 200 from its designated sorting zone to any further destination as directed by port logistics systems or operator instructions.

In some preferred embodiments, the system 100 may transport the shipping container 200 to one of a plurality of sorting zones based on instructions stored in its algorithm, instructions received from an operator 300, or a code on the shipping container readable by a navigation camera 112 integrated into the system 100. For instance, a port that separates shipping containers 200 by destination region might have one sorting zone for goods bound for the eastern seaboard, another for goods destined for the midwest, and another for goods heading to the western states. The system 100 might then be instructed by an operator 300 to transport containers from a particular vessel to the appropriate designated sorting zone based on their routing information. Alternatively, the system 100 may read barcodes or QR codes affixed to containers that indicate their intended destination and autonomously navigate to the corresponding sorting zone. In some instances, the port management system may dynamically assign sorting zones based on current capacity and throughput requirements. The method 800 may then proceed to terminal step 835, indicating the completion of the scanning and sorting process for that particular container.

In step 840, the system 100 may send an alert to one or more operators 300 indicating a potential hazard associated with the scanned shipping container 200. In a preferred embodiment, this alert can be sent to the local handset via Bluetooth, providing immediate notification to the operator controlling the system 100. In another preferred embodiment, this alert may be sent to one or more operators 300 via text message, email, or a dedicated messaging application used by port security personnel. In some preferred embodiments, this alert can be sent to one or more safety professionals who possess specialized training in handling hazardous materials. For instance, a professional hazardous materials response team might be alerted to the presence of elevated volatile organic compounds indicating the potential risk of combustible or explosive materials. Alternatively, the alert may be sent to one or more law enforcement professionals when the scan data suggests criminal activity, such as when thermal imaging indicates the presence of one or more humans inside the shipping container, potentially indicating human trafficking or smuggling operations.

In branching step 845, the shipping container 200 may be further categorized as medium-risk or high-risk based on its risk data and the severity of detected anomalies. If the container is determined to be high-risk, the method 800 may proceed to step 865 for enhanced safety protocols. If the container is determined to be medium-risk, the method 800 may proceed to step 850 for secure handling procedures. During step 850, the system 100 can transport the shipping container 200 to a designated secure zone for further inspection by the appropriate professionals. In a preferred embodiment, the system 100 may emit an alarm 704 during transit to alert nearby individuals to the presence of potentially hazardous materials being transported. In another preferred embodiment, the designated secure zone may be an area or edifice that is separated from the rest of the port to prevent unauthorized access and reduce the risk of damage in the event of hazardous leakage, chemical release, or explosion.

For instance, a reinforced warehouse with automatic doors that open for authorized operators or systems 100 might serve as a designated secure zone where specialized inspection equipment is available. Alternatively, a fenced-off area of the port with posted warnings and controlled access points might suffice as a designated secure zone for medium-risk containers awaiting inspection. In some instances, the designated secure zone may include ventilation systems, containment features, or other safety infrastructure appropriate for handling potentially hazardous cargo. During step 855, the shipping container 200 can be unloaded from the system 100, and the system may withdraw to allow access by the appropriate professionals who will conduct detailed inspections. The system 100 may then be available to return to container handling operations or may remain on standby pending the outcome of the inspection. The method 800 may then proceed to terminal step 860, indicating the completion of the system's role in handling that particular medium-risk container.

The present disclosure contemplates that high-risk containers may be determined to present too great a risk to move automatically without additional precautions and human oversight. To address this elevated risk level, during step 865, the system 100 may transmit an alert to one or more operators 300 indicating its current location and the nature of the detected threat. In a preferred embodiment, the alert can be sent to the operators who were alerted in step 840, ensuring continuity of communication throughout the incident response. In another preferred embodiment, the alert may comprise locational data in the form of a particular ship name, berth number, or dock identifier that allows responders to quickly locate the system 100. For instance, the alert might read “elevated radiation levels detected at berth 7, pier 3” to provide clear geographic reference for emergency responders. In some preferred embodiments, the alert may comprise specific directions indicating where at a dock or on a ship the hazardous container is located relative to landmarks or grid coordinates used by port personnel.

In some instances, the alert may comprise locational data in the form of GPS coordinates that can be input into navigation systems used by emergency response vehicles. The alert may optionally include a summary of the detected threat indicators, such as the type of sensor that triggered the high-risk classification and the magnitude of the detected anomaly. In step 870, the system 100 may halt in place and emit an audible alarm 704 indicating the presence of a hazardous material to warn nearby personnel. In a preferred embodiment, this alarm can be a klaxon, siren, or horn typically associated with danger that is recognizable to port workers and emergency responders. In another preferred embodiment, this alarm may comprise a pre-recorded message played through a speaker warning those nearby that a hazardous substance has been detected and that they should evacuate the immediate area. For instance, a loud message might play repeating “Caution! Potential hazard detected! Please clear the area immediately!” to provide clear instructions to nearby personnel.

In some preferred embodiments, both a spoken message and a wordless klaxon, horn, or siren may be emitted simultaneously or in alternating sequence to maximize the likelihood that nearby individuals will be alerted to the hazard. The alarm 704 may be configured to continue sounding until an operator 300 instructs it to shut off through the local handset, the control panel in the cab 102, or a remote command sent via the communications interface 702. For instance, a safety team that has successfully established a perimeter to prevent unauthorized individuals from accessing the area might shut off the alarm to reduce distractions while they inspect the shipping container 200 and assess the situation. In some instances, the alarm 704 may automatically reduce in volume or frequency after a predetermined period while continuing to provide visual indicators of the hazard condition. Optionally, the system 100 may continue to transmit periodic status updates to monitoring stations until the situation has been resolved and the container has been cleared or removed by appropriate personnel. The method 800 may then proceed to terminal step 875, indicating the completion of the automated response protocol for that particular high-risk container.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

1. A system for scanning and transporting shipping containers, comprising:
a rectangular bed configured to support a shipping container positioned thereon;
a sensor integrated about the rectangular bed and configured to detect a presence of the shipping container on the rectangular bed;
a plurality of wheels configured to allow omnidirectional movement of the system;
one or more engines operably connected to the plurality of wheels;
a scanning collar configured to gather data from the shipping container on the rectangular bed, wherein the scanning collar comprises one or more sensors and is configured to traverse a length of the rectangular bed with the one or more sensors active;
a communications interface comprising a transmitter and a receiver;
an alarm;
one or more cameras configured to gather visual data of surroundings of the system; and
a computing entity comprising a processor and a non-transitory computer-readable medium coupled to the processor, wherein the computing entity is operably connected to the sensor integrated about the rectangular bed, the alarm, the communications interface, the one or more engines, and the scanning collar, and wherein the non-transitory computer-readable medium contains instructions which, when executed by the processor, cause the processor to perform operations comprising:
detecting the presence of the shipping container on the rectangular bed;
initiating a scan of the shipping container using the scanning collar;
collecting data from the scan of the shipping container;
interpreting the data from the scan to determine a risk level of the shipping container; and
directing the system to travel to a predetermined location based on the risk level of the shipping container.

2. The system of claim 1, wherein the plurality of wheels comprises Mecanum wheels.

3. The system of claim 2, wherein the plurality of wheels comprises four Mecanum wheels positioned at corners of the rectangular bed.

4. The system of claim 1, wherein the one or more sensors of the scanning collar comprise at least one of:
an X-ray scanner;
a gamma ray scanner;
a thermal camera;
a radiation detector;
a volatile organic compound detector; and
a spectroscopic analyzer.

5. The system of claim 4, wherein the scanning collar comprises a collar frame configured in a horseshoe shape with an internal diameter sufficient to fit about a shipping container.

6. The system of claim 1, wherein the sensor integrated about the rectangular bed comprises at least one of a pressure sensor or a camera.

7. The system of claim 1, wherein the communications interface is configured to receive signals via Bluetooth from a handset operated by an operator.

8. The system of claim 7, wherein the non-transitory computer-readable medium contains instructions which, when executed by the processor, further cause the processor to perform operations comprising:
interpreting signals from the handset via Bluetooth to generate a set of directives for operation of the system; and
controlling a direction, rotation, and speed of motion of the system based on the signals.

9. The system of claim 1, wherein the alarm comprises at least one of a mechanical horn or a speaker.

10. The system of claim 1, further comprising a driving station operably connected to the rectangular bed, wherein the driving station comprises a control panel configured to be operated by an operator to control the system.

11. The system of claim 10, wherein the driving station further comprises an enclosed cab with a cab window.

12. A method for scanning and sorting shipping containers, comprising:
interpreting signals from a local handset via a wireless communication protocol to generate a set of directives for operation of a system comprising a rectangular bed;
controlling a direction, rotation, and speed of motion of the system based on the signals;
detecting a presence of a shipping container on the rectangular bed;
initiating a scan of the shipping container using a scanning collar configured to traverse a length of the rectangular bed;
collecting data from the scan of the shipping container;
interpreting the data from the scan to determine a risk level of the shipping container; and
directing the system to travel to a predetermined location based on the risk level of the shipping container.

13. The method of claim 12, wherein the wireless communication protocol comprises Bluetooth.

14. The method of claim 12, wherein collecting data from the scan of the shipping container comprises collecting data from at least one of an X-ray scanner, a gamma ray scanner, a thermal camera, a radiation detector, a volatile organic compound detector, or a spectroscopic analyzer integrated within the scanning collar.

15. The method of claim 14, further comprising:
transmitting an alert pertaining to the risk level to one or more computing devices; and
activating an alarm based on the risk level of the shipping container.

16. The method of claim 15, wherein the predetermined location comprises a designated sorting zone when the risk level indicates low risk and a designated secure zone when the risk level indicates medium or high risk.

17. A system for scanning shipping containers, comprising:
a bed configured to support a shipping container;
a scanning collar configured to traverse a length of the bed, the scanning collar comprising a collar frame and a plurality of sensors integrated within the collar frame, wherein the plurality of sensors comprises at least two of: an X-ray scanner, a thermal camera, a radiation detector, a volatile organic compound detector, and a spectroscopic analyzer;
a computing entity comprising a processor and a non-transitory computer-readable medium, wherein the computing entity is operably connected to the scanning collar; and
a communications interface configured to transmit data collected by the plurality of sensors to one or more external computing devices;
wherein the non-transitory computer-readable medium contains instructions which, when executed by the processor, cause the processor to perform operations comprising:
activating the plurality of sensors during traversal of the scanning collar along the bed;
collecting data from the plurality of sensors; and
analyzing the collected data to determine a risk level associated with contents of the shipping container.

18. The system of claim 17, wherein the collar frame is configured in a horseshoe shape with an internal diameter sufficient to encompass three sides of the shipping container.

19. The system of claim 17, further comprising an alarm operably connected to the computing entity, wherein the non-transitory computer-readable medium contains instructions which, when executed by the processor, further cause the processor to perform operations comprising activating the alarm when the risk level exceeds a predetermined threshold.

20. The system of claim 19, wherein the alarm comprises at least one of a siren, a horn, or a speaker configured to emit a pre-recorded voice message.
